(19) United States
(12) Patent Application Publication
(10) Pub. No.: US 2010/0157339 A1
(43) Pub. Date: Jun. 24, 2010

(54) DATA PROCESSING DEVICE

(75) Inventor: Ryuji YAMADA, Ogaki-shi (JP)

Correspondence Address: Scully, Scott, Murphy & Presser, P.C., 400 Garden City Plaza, Suite 300, Garden City, NY, 11530, US

(73) Assignee: BROTHER KOGYO KABUSHIKI KAISHA, Aichi-ken (JP)

(21) Appl. No.: 12/633,350

(22) Filed: Dec. 8, 2009

(30) Foreign Application Priority Data
Dec. 23, 2008 (JP) 2008-326721

(51) Int. Cl. H04N 1/60

(52) U.S. Cl. 358/1.9

(57) ABSTRACT

A data processing device is used for a printing device including a printing unit for printing an image based on image data using color material contained in a cartridge. The cartridge is detachably mounted in the printing device and has a storage unit storing processing data. The data processing device includes an original image data acquiring unit, a processing data acquiring unit, a first processing unit, a second processing unit, and a supplying unit. The original image data acquiring unit is configured to acquire original image data. The processing data acquiring unit is configured to acquire the processing data from the storage unit. The first processing unit is configured to generate first image data using the original image data based on the acquired processing data if the processing data acquiring unit acquires processing data. The first image data is used for producing a first image by the printing unit. The second processing unit is configured to generate second image data using the original image data if the processing data acquiring unit does not acquire the processing data. The second image data is used for producing a second image by the printing unit. The second image has a density higher than a density of the first image. The supplying unit is configured to supply one of the first image data and the second image data to the printing unit.

### CROSS REFERENCE TO RELATED APPLICATION

This application claims priority from Japanese Patent Application No. 2008-326721 filed Dec. 23, 2008. The entire content of the priority application is incorporated herein by reference.

### TECHNICAL FIELD

The present invention relates to a data processing device.

### BACKGROUND

Conventionally, printers have been provided with a detachably mounted cartridge accommodating a colorant, such as ink or toner. Since the printed images formed by the printer varies according to the properties of the colorant, it is desirable to have the printer perform image processing on the image data based on the properties of the colorant.

One conventional printer provides the cartridge with a memory device for storing image processing data that the printer can access when processing image data. By referencing this image processing data, the printer can execute an image process suited to the properties of colorant accommodated in the cartridge in order to produce a desired printed image.

However, when executing the image process described above using the image processing data, the conventional printer does not sufficiently account for cases in which the colorant accommodated in the cartridge differs from the colorant recommended by the manufacturer of the printer; for example, when the user mounts a cartridge that is not officially approved by the manufacturer or a cartridge that has been refilled with a different type of colorant. In such cases, the printed images produced on the printer often include indistinct areas that decrease the usefulness of the printed image.

### SUMMARY

In view of the foregoing, it is an object of the present invention to provide a technology for producing printed images on a printer that are clearly visible, even when the colorant accommodated in the cartridges is not a colorant approved by the manufacturer.

In order to attain the above and other objects, the invention provides a data processing device for a printing device including a printing unit. The printing unit prints an image based on image data using color material contained in a cartridge. The cartridge is detachably mounted in the printing device and has a storage unit storing processing data. The data processing device includes an original image data acquiring unit, a processing data acquiring unit, a first processing unit, a second processing unit, and a supplying unit. The original image data acquiring unit is configured to acquire original image data. The processing data acquiring unit is configured to acquire the processing data from the storage unit. The first processing unit is configured to generate first image data using the original image data based on the acquired processing data if the processing data acquiring unit acquires processing data, the first image data being used for producing a first image by the printing unit. The second processing unit is configured to generate second image data using the original image data if the processing data acquiring unit does not acquire the processing data. The second image data is used for producing a second image by the printing unit. The second image has a density higher than a density of the first image. The supplying unit is configured to supply one of the first image data and the second image data to the printing unit.

According to another aspect, the present invention provides a data processing device for a printing device including a printing unit. The printing unit prints an image based on image data using color material contained in a cartridge. The cartridge is detachably mounted in the printing device and has a storage unit storing processing data. The data processing device includes an original image data acquiring unit, a processing data acquiring unit, a processing data determining unit, a first processing unit, a second processing unit, and a supplying unit. The original image data acquiring unit is configured to acquire original image data. The processing data acquiring unit is configured to acquire the processing data from the storage unit. The determining unit is configured to determine whether or not the acquired processing data is suitable for characteristic of color material contained in the cartridge. The first processing unit is configured to generate first image data using the original image data based on the acquired processing data if the acquired processing data is suitable, the first image data being used for producing a first image by the printing unit. The second processing unit is configured to generate second image data using the original image data if the acquired processing data is not suitable. The second image data is used for producing a second image by the printing unit. The second image has a density higher than a density of the first image. The supplying unit is configured to supply one of the first image data and the second image data to the printing unit.

According to another aspect, the present invention provides a data processing method comprising: acquiring original image data; attempting to acquire processing data from a storage unit of a cartridge, the cartridge being detachably mounted in a printing device and containing color material therein, the printing device including a printing unit for printing an image based on image data using the color material; generating first image data using the original image data based on the acquired processing data if the processing data is acquired, the first image data being used for producing a first image by the printing unit; generating second image data using the original image data if the processing data is not acquired, the second image data being used for producing a second image by the printing unit, the second image having a density higher than a density of the first image; and supplying one of the first image data and the second image data to the printing unit.

According to another aspect, the present invention provides a data processing method comprising: acquiring original image data; acquiring processing data from a storage unit of a cartridge, the cartridge being detachably mounted in a printing device and containing color material therein, the printing device including a printing unit for printing an image based on image data using the color material; determining whether or not the acquired processing data is suitable for characteristic of color material contained in the cartridge; generating first image data using the original image data based on the acquired processing data if the acquired processing data is suitable, the first image data being used for producing a first image by the printing unit; generating second image data using the original image data if the acquired processing data is not suitable, the second image data being used for producing a second image by the printing unit, the second image having a density higher than a density of the first image; and supplying one of the first image data and the second image data to the printing unit.

According to another aspect, the present invention provides a computer-readable recording medium that stores a data processing program, the data processing program comprising instructions for: acquiring original image data; attempting to acquire processing data from a storage unit of a cartridge, the cartridge being detachably mounted in a printing device and containing color material therein, the printing device including a printing unit for printing an image based on image data using the color material; generating first image data using the original image data based on the acquired processing data if the processing data is acquired, the first image data being used for producing a first image by the printing unit; generating second image data using the original image data if the processing data is not acquired, the second image data being used for producing a second image by the printing unit, the second image having a density higher than a density of the first image; and supplying one of the first image data and the second image data to the printing unit.

According to another aspect, the present invention provides a computer-readable recording medium that stores a data processing program, the data processing program comprising instructions for: acquiring original image data; acquiring processing data from a storage unit of a cartridge, the cartridge being detachably mounted in a printing device and containing color material therein, the printing device including a printing unit for printing an image based on image data using the color material; determining whether or not the acquired processing data is suitable for characteristic of color material contained in the cartridge; generating first image data using the original image data based on the acquired processing data if the acquired processing data is suitable, the first image data being used for producing a first image by the printing unit; generating second image data using the original image data if the acquired processing data is not suitable, the second image data being used for producing a second image by the printing unit, the second image having a density higher than a density of the first image; and supplying one of the first image data and the second image data to the printing unit.

### BRIEF DESCRIPTION OF THE DRAWINGS

The particular features and advantages of the invention as well as other objects will become apparent from the following description taken in connection with the accompanying drawings, in which:

FIG. 1 is a block diagram showing a data processing device according to a first embodiment of the invention;

FIG. 2 is a diagram showing a data structure of ROM provided in the data processing device according to the first embodiment;

FIG. 3 is a diagram showing a data structure of flash memory provided in the data processing device according to the first embodiment;

FIG. 4 is a diagram showing a data structure of ROM provided in a developer cartridge mounted in the data processing device according to the first embodiment;

FIG. 5 is a diagram showing a data structure of flash memory provided in the developer cartridge according to the first embodiment;

FIG. 6 is a flowchart illustrating steps in a mounting process executed by the data processing device according to the first embodiment;

FIG. 7 is a flowchart illustrating steps in a test patch measurement process executed by the data processing device according to the first embodiment;

FIG. 8(a) is an explanatory diagram illustrating how to measure densities of test patches in the test patch measurement process;

FIG. 8(b) is a graph illustrating relationships between set values and density sensor values measured by a density sensor of the data processing device;

FIG. 8(c) is an explanatory diagram illustrating how to calculate measured densities based on the sensor densities;

FIG. 8(d) is a graph illustrating relationships between the set values and the measured densities;

FIG. 9 is a flowchart illustrating steps in a printing process executed by the data processing device according to the first embodiment;

FIG. 10 is an explanatory diagram showing how to create first and second calibration tables by the data processing device according to the first embodiment;

FIG. 11(a) is a graph illustrating relationships between the first and second calibration tables for cyan;

FIG. 11(b) is a graph illustrating relationships between the first and second calibration tables for magenta;

FIG. 11(c) is a graph illustrating relationships between the first and second calibration tables for yellow;

FIG. 11(a) is a graph illustrating relationships between the first and second calibration tables for black;

FIG. 12 is a diagram showing a data structure of ROM provided in a data processing device according to a second embodiment;

FIG. 13 is a flowchart illustrating steps in a test patch measurement process executed by the data processing device according to the second embodiment;

FIG. 14 is a flowchart illustrating steps in a printing process executed by the data processing device according to the second embodiment;

FIG. 15 is a diagram showing a data structure of ROM provided in a data processing device according to a third embodiment;

FIG. 16 is a flowchart illustrating steps in a test patch measurement process executed by the data processing device according to the third embodiment;

FIG. 17 is an explanatory diagram showing how to create first and second calibration tables by the data processing device according to the third embodiment;

FIG. 18 is a flowchart illustrating steps in a printing process executed by the data processing device according to the third embodiment;

FIG. 19 is a diagram showing a data structure of ROM provided in a data processing device according to a fourth embodiment;

FIG. 20(a) is a graph showing a part of first color profile used when color changes from white to black through blue;

FIG. 20(b) is a graph showing a part of the first color profile used when color changes from white to black through green;

FIG. 20(c) is a graph showing a part of the first color profile used when color changes from white to black through red;

FIG. 21(a) is a graph showing a part of second color profile used when color changes from white to black through blue;

FIG. 21(b) is a graph showing a part of the second color profile used when color changes from white to black through green;

FIG. 21(c) is a graph showing a part of the second color profile used when color changes from white to black through red;

FIG. 22 is a flowchart illustrating steps in a test patch measurement process executed by the data processing device according to the fourth embodiment; and

FIG. 23 is a flowchart illustrating steps in a printing process executed by the data processing device according to the fourth embodiment.

### DETAILED DESCRIPTION

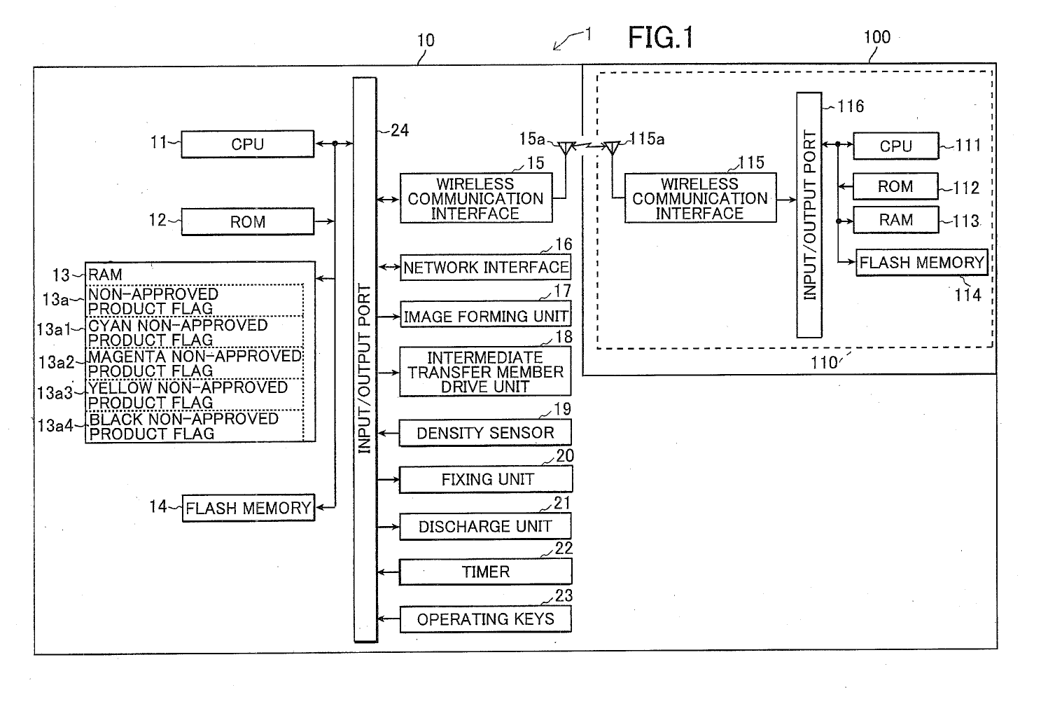

A data processing device according to embodiments of the invention will be described while referring to the accompanying drawings wherein like parts and components are designated by the same reference numerals to avoid duplicating description. As shown in FIG. 1, a control system 1 includes a multifunction peripheral 1 (MFP 10) and a cartridge 100 that is detachably mounted on the MFP 10.

The MFP 10 is a multifunction device capable of performing a printing function, scanning function, telephone function, and the like. When the MFP 10 is set to the printing function, the MFP 10 serves as a transfer belt type laser printer for printing an image subject to print on a recording sheet. Four colors of toner accommodated in the cartridge 100 are cyan (C), magenta (M), yellow (Y), and black (K).

The MFP 10 includes a CPU 11, a ROM 12, a RAM 13, a flash memory 14, a wireless communication interface 15, a network interface 16, an image forming unit 17, an intermediate transfer member drive unit 18, a density sensor 19, a fixing unit 20, a discharge unit 21, a timer 22, operating keys 23, and an input/output port 24. The CPU 11, the ROM 12, the RAM 13, and the flash memory 14 are connected to each other via a bus line. The CPU 11, the ROM 12, the RAM 13, and the flash memory 14 are connected to each component 15-23 via the input/output port 24.

The CPU 11 is a microprocessor for executing various programs stored in the ROM 12. The ROM 12 is a read-only memory for storing programs executed by the CPU 11 and for storing constants and tables that the CPU 11 refers to when executing the programs.

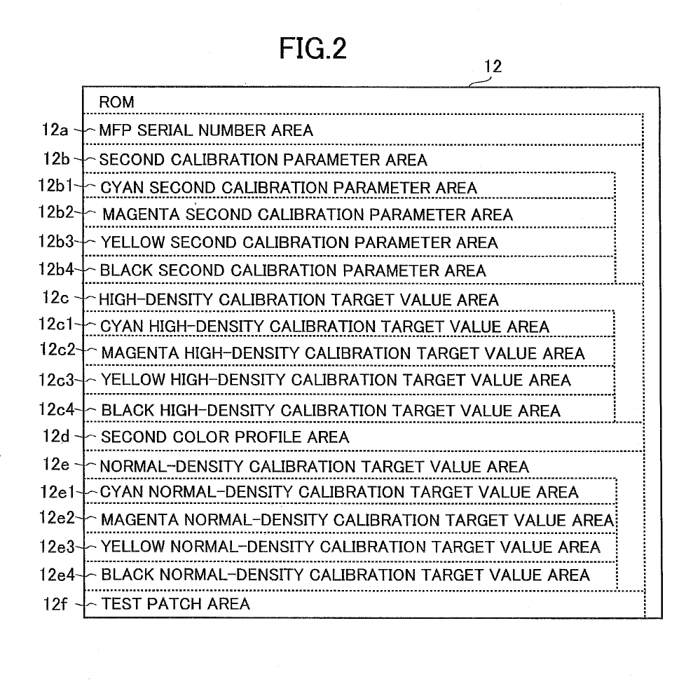

As shown in FIG. 2, the ROM 12 includes a MFP serial number area 12a, a second calibration parameter area 12b, a high-density calibration target value area 12c, a second color profile area 12d, a normal-density calibration target value area 12e, and a test patch area 12f.

The MFP serial number area 12a stores a serial number uniquely assigned to the MFP 10 at the factory. The second calibration parameter area 12b stores second calibration parameters used when performing density calibration (hereinafter simply referred to as “calibration”) for images to be formed on paper. The second calibration parameters are used when the toner accommodated in the cartridge 100 mounted on the MFP 10 is not toner approved by the manufacturer (hereinafter referred to as a “non-approved product”). Second calibration parameters are provided for each of the colors C, M, Y, and K. The second calibration parameter area 12b has individual areas 12b1, 12b2, 12b3, and 12b4 for respectively storing second calibration parameters for cyan, magenta, yellow, and black.

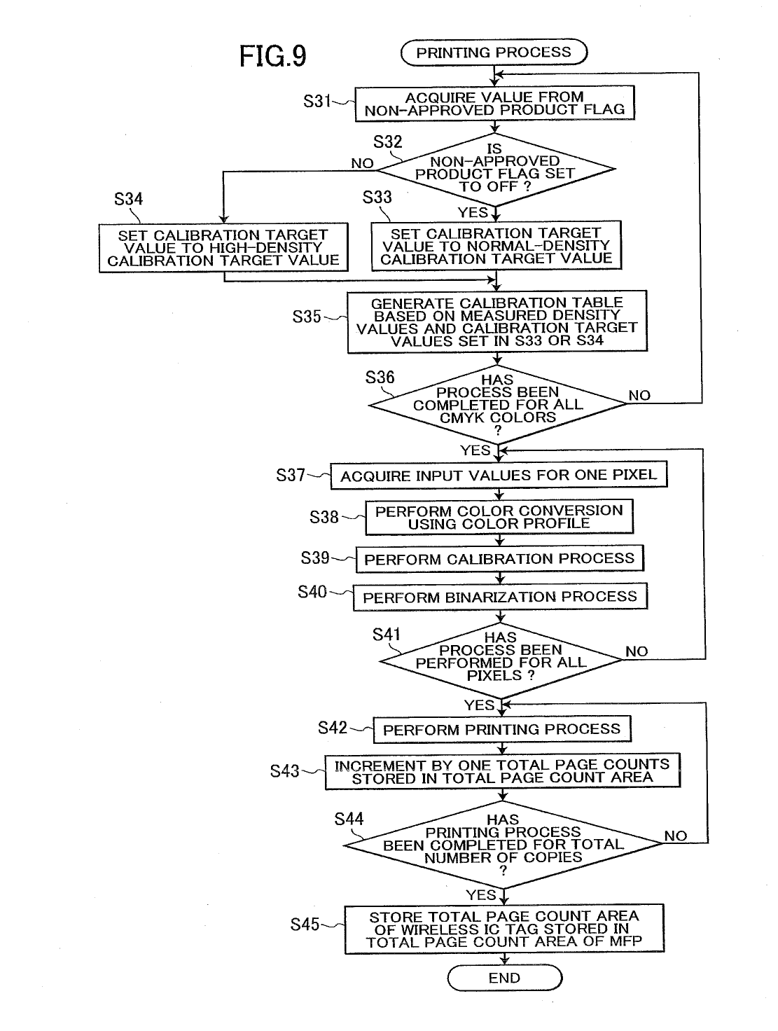

The image process performed by the MFP 10 includes a color conversion process and a calibration process (a process to adjust gradation values) executed in sequence. The color conversion process is performed to convert RGB values in pixel data constituting the original image data to gradation values for four colors in the CMYK space (CMYK values) using color profiles (3D lookup tables) described later. The subsequently executed calibration process is performed to calibrate the CMYK value in pixel data of the image data after undergoing color conversion using a calibration table described later to produce C′M′Y′K′ values. In this description, “original image data” will denote the unprocessed image data, and specifically image data in the state prior to undergoing the printing process of FIG. 9 described later.

In the printing process described later, the MFP 10 applies a dither pattern to the C′M′Y′K′ values of pixel data constituting the calibrated image data in order to convert the pixel data in this calibrated image data to binary data (hereinafter referred to as “processed image data”) comprising ON/OFF values. The MFP 10 subsequently forms the processed image on paper using the processed image data.

The high-density calibration target value area 12c stores high-density calibration target values set as the target values for the calibration process when the toner accommodated in the cartridge 100 is a non-approved product. The high-density calibration target values are provided for each of the colors C, M, Y, and K. The high-density calibration target value area 12c has individual areas 12c1, 12c2, 12c3, and 12c4 for respectively storing high-density calibration target values for cyan, magenta, yellow, and black.

The second color profile area 12d stores second color profiles for use when the toner accommodated in the cartridge 100 of the MFP 10 is a non-approved product. In the following description, a “color profile” denotes data in the form of a 3D lookup table used to determine how RGB values (values from 0 to 255) in pixel data constituting original image data are to be converted to CMYK values (values from 0 to 255) in pixel data constituting color converted image data. The second color profile is an unoptimized generic color profile used for the non-approved product.

The normal-density calibration target value area 12e stores normal-density calibration target values set as the target values for the calibration process when the toner accommodated in the cartridge 100 is toner approved by the manufacturer of the MFP 10 (hereinafter referred to as an “approved product”). The normal-density calibration target values are provided for each of the colors C, M, Y, and K. The normal-density calibration target value area 12e has individual areas 12e1, 12e2, 12e3, and 12e4 for respectively storing normal-density calibration target values for cyan, magenta, yellow, and black.

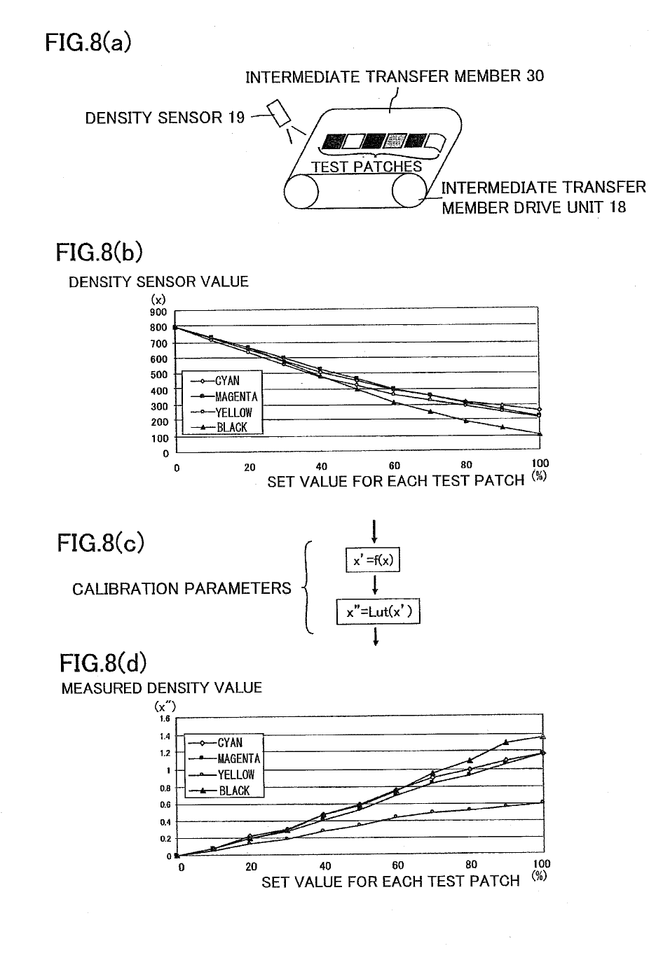

The test patch area 12f stores test patch data used when forming a plurality of test patches in each of the C, M, Y, and K colors and at various set values (11 densities at regular intervals in the first embodiment). The test patch data is printed on an intermediate transfer member 30 (see FIG. 8) driven by the intermediate transfer member drive unit 18 when the user inputs an instruction to execute the calibration process through an operation on the operating keys 23.

Returning to FIG. 1, the RAM 13 has a work area in which the CPU 11 temporarily stores variables and the like when executing programs. The RAM 13 includes non-approved product flags 13a. The non-approved product flags 13a are turned off when toner of cartridge 100 mounted on the MFP 10 is an approved product. The non-approved product flags 13a are turned on when toner of cartridge 100 mounted on the MFP 10 is a non-approved product. The non-approved product flags 13a are provided for each of the colors C, M, Y, and K. The non-approved product flags 13a have individual areas 13a1, 13a2, 13a3, and 13a4 for cyan, magenta, yellow, and black, respectively.

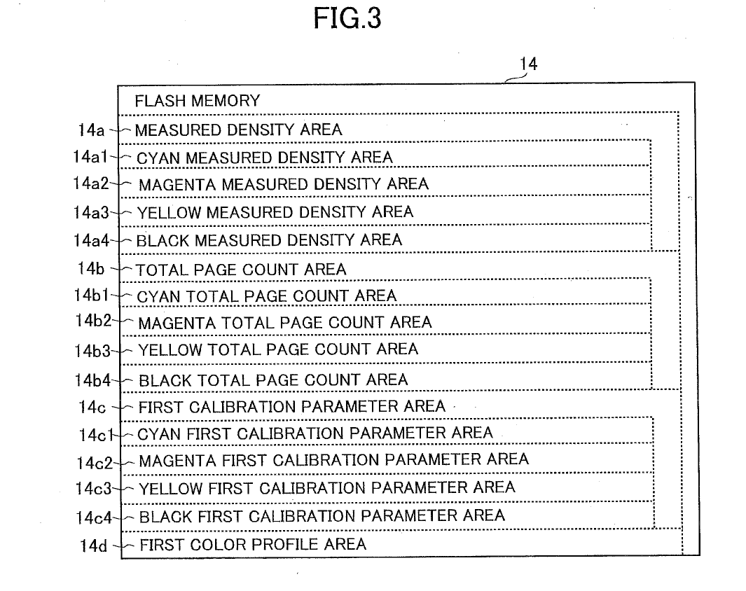

The flash memory 14 is a rewritable nonvolatile memory device storing various data. As shown in FIG. 3, the flash memory 14 includes a measured density area 14a, a total page count area 14b, a first calibration parameter area 14c, and a first color profile area 14d.

The measured density area 14a stores measured density values for each of the CMYK colors, and specifically densities for test patches formed on the intermediate transfer member 30 (see FIG. 8) in each of the CMYK colors measured by the density sensor 19 in the calibration process. The measured density area 14a has individual areas 14a1, 14a2, 14a3, and 14a4 for respectively storing measured density for cyan, magenta, yellow, and black.

The total page count area 14b stores a total page count indicating a number of recording sheets that have been printed by using the printing function by the MFP 10 until present time. The total page count area 14b has individual areas 14b1, 14b2, 14b3, and 14b4 for respectively storing the total page count for cyan, magenta, yellow, and black.

The first calibration parameter area 14b stores first calibration parameters. The first calibration parameters are transmitted from a wireless IC tag 110 (described later) that is embedded in the cartridge 100 when the toner accommodate in the cartridge 100 is an approved product. The first calibration parameters are used, when the MFP 10 performs calibration and the toner of the cartridge 100 mounted on the MFP 10 is an approved product. The first calibration parameters are provided for each of the colors C, M, Y, and K. The first calibration parameter area 14c has individual areas 14c1, 14c2, 14c3, and 14c4 for respectively storing first calibration parameters for cyan, magenta, yellow, and black.

The first color profile area 14d stores first color profiles for use when the toner accommodated in the cartridge 100 of the MFP 10 is an approved product. The first color profiles are transmitted from the wireless IC tag 110 (described later) that is embedded in the cartridge 100 when the toner accommodate in the cartridge 100 is an approved product. The first color profile is optimized by the manufacturer for toner accommodated in the cartridge 100.

Returning to FIG. 1, the wireless communication interface 15 is an interface for communicating with the wireless IC tag 110 wirelessly and has an antenna 15a transmitting an receiving signals used for wireless communication. The network interface 16 is an interface enabling to perform communication via LAN, an Internet, and the like.

The image-forming unit 17 primarily includes photosensitive drums, chargers, and a laser irradiation device (none of which are shown in the drawings). The image-forming unit 17 charges the cylindrical photosensitive drums with the corresponding chargers and rotates the drums about their axes. The laser irradiation device then outputs laser beams that are irradiated onto the photosensitive drums based on processed image data supplied by the CPU 11. Next, a toner image corresponding to the processed image data is formed on each photosensitive drum by depositing toner in the respective color accommodated in the cartridge 100 on the respective photosensitive drum.

The intermediate transfer member drive unit 18 is primarily configured of the intermediate transfer member 30 (see FIG. 8) and a motor (not shown) for driving the intermediate transfer member 30. The intermediate transfer member 30 is an elastic belt whose outer surface is in contact with the photosensitive drums. When the intermediate transfer member 30 is driven to circulate by the motor, the photosensitive drums contacting the surface of the intermediate transfer member 30 also rotate about their axes while the toner images formed on the photosensitive drums are transferred onto the intermediate transfer member 30. The toner images transferred onto the intermediate transfer member 30 are subsequently transferred onto a sheet of paper to form the printed image.

When the CPU 11 supplies the test patch data stored in the test patch area 12f to the image-forming unit 17, the image-forming unit 17 forms toner images corresponding to each test patch on the photosensitive drums and transfers the toner images onto the intermediate transfer member 30. Accordingly, the image-forming unit 17 forms each test patch on the intermediate transfer member 30.

The density sensor 19 is configured to measure densities of test patches formed on the intermediate transfer member 30 (FIG. 8). The fixing unit 20 fixes the images transferred to the recording sheet by heating and pressurizing toner adhered to the recording sheet. The discharge section 21 discharges the recording sheet on which toner has been fixed outside of the MFP 10. The timer 22 measures a present time and date. The operating keys 23 enable the user to input a prescribed instruction to the MFP 10.

The wireless IC tag 110 embedded in the cartridge 100 includes a CPU 111, a ROM 112, a RAM 113, a flash memory 114, a wireless interface 115, and an input/output port 116. The CPU 111, ROM 112, RAM 113, and flash memory 114 are connected to each other via bus lines. The CPU 111, ROM 112, RAM 113, flash memory 114, and wireless interface 115 are connected to each other via the input/output port 116. The wireless IC tag 110 includes a battery (not shown) that supplying power to each of components 111-116.

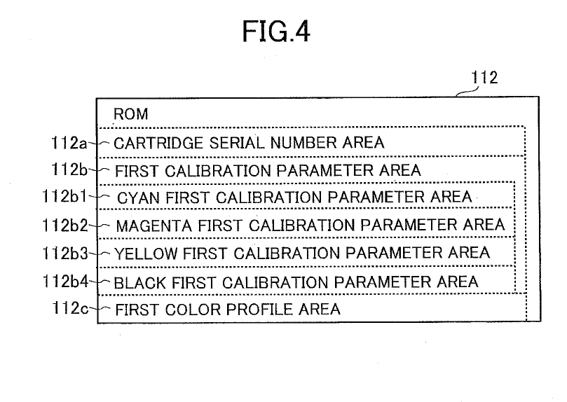

As shown in FIG. 4, the ROM 112 includes a cartridge serial number area 112a, a first calibration parameter area 112b, and a first color profile area 112c. The cartridge serial number area 112a stores a serial number uniquely assigned to the cartridge 100 in the factory.

The first calibration parameter area 112b stores first calibration parameters to be transmitted to the MFP 10. The first calibration parameters are provided for each of the colors C, M, Y, and K. The first calibration parameter area 112b has individual areas 112b1, 112b2, 112b3, and 112b4 for respectively storing first calibration parameters for cyan, magenta, yellow, and black. The first color profile area 112c stores a first color profile to be transmitted to the MFP 10.

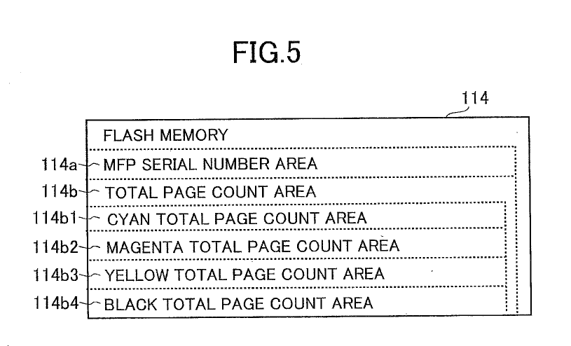

As shown in FIG. 5, the flash memory 114 includes a MFP serial number area 114a, and a total page count area 114b. The MFP serial number area 114a stores the serial number of the MFP 10 when the CPU 111 receives this serial number from the MFP 10 via the wireless communication interface 115.

The total page count area 114b stores a total page count indicating a number of recording sheets for each of CMYK colors when the CPU 111 receives the total page count transmitted from the MFP 10 via the wireless communication interface 115. The total page count area 114b has individual areas 114b1, 114b2, 114b3, and 114b4 for respectively storing the total page count stored in the areas 14b1, 14b2, 14b3, and 14b4.

The wireless communication interface 115 is an interface for communicating with the wireless communication interface 15 wirelessly and has an antenna 115a transmitting and receiving signals used for wireless communication.

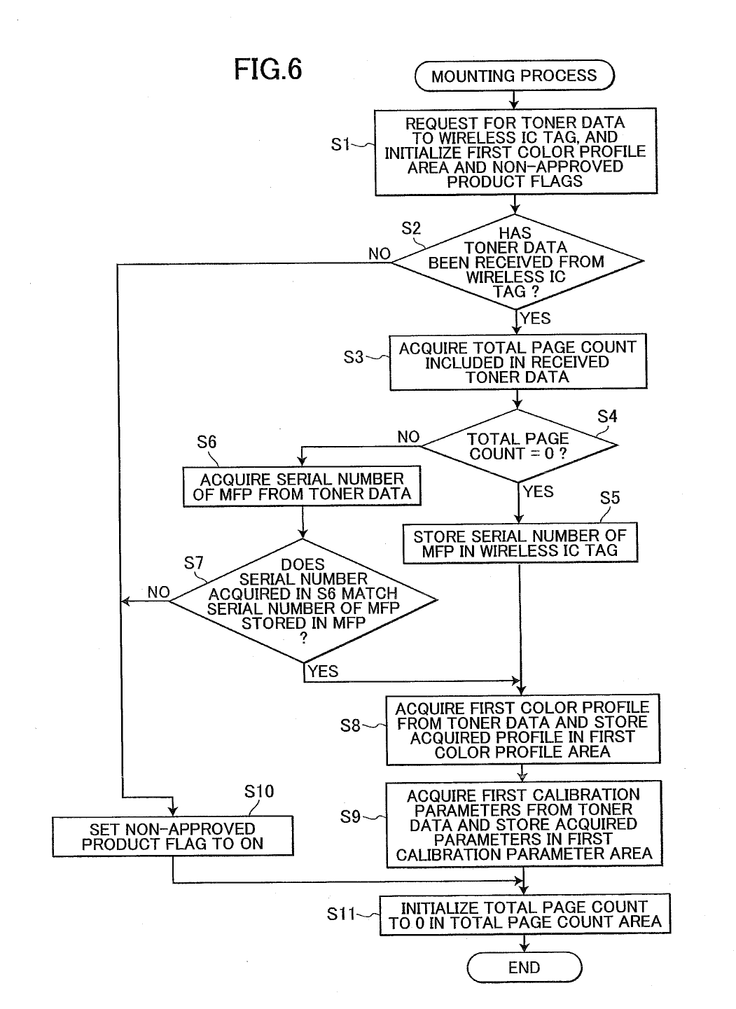

A mounting process will be described with reference to FIG. 6. In S1 of the mounting process, the CPU 11 outputs a signal to the wireless IC tag 110 built into the mounted cartridge 100 requesting the transmission of toner data. Also in the process of S1, the CPU 11 initializes the first color profile area 14d, erasing first color profiles from the first color profile area 14d that was acquired from a previous cartridge used in the MFP 10; and sets all of the non-approved product flags 13a1-13a4 to OFF, thereby resetting any of the non-approved product flags 13a1-13a4 that were set to ON for the previously mounted cartridge.

The toner data that the CPU 11 requests in S1 includes the first calibration parameters and first color profiles stored in the ROM 112 of the wireless IC tag 110, and the MFP serial number and total page counts stored in the flash memory 114. The remaining process in S2-S11 of FIG. 6 is actually performed once for each of the colors C, M, Y, and K, but the following description will only cover the case of C (cyan).

In S2 the CPU 11 determines if toner data has been received from the wireless IC tag 110. If toner data has not been returned within a prescribed time (S2: NO), the CPU 11 determines or judges that a wireless IC tag 110 is not built into the cartridge 100 and that the cartridge 100 is a non-approved product. Thus, the CPU 11 determines that the cyan toner accommodated in the non-approved cartridge 100 is a non-approved product. Accordingly, in S10 the CPU 11 sets the cyan non-approved product flag 13a1 to ON, and subsequently advances to S11.

However, if the CPU 11 determines in S2 that toner data was received (S2: YES), in S3 the CPU 11 acquires the total page count for cyan included in the received data. In S4 the CPU 11 determines whether this total page count for cyan is 0. If the total page count is 0 (S4: YES), the CPU 11 judges the cyan toner cartridge 100 to be an unused, approved product and that the acquired toner data conforms to the properties of cyan toner accommodated in the cartridge 100. Therefore, the CPU 11 determines that the MFP serial number area 114a of the wireless IC tag 110 does not store the MFP serial number. Hence, in S5 the CPU 11 registers the serial number of the MFP 10 in the MFP serial number area 114a of the wireless IC tag 110, and subsequently advances to S8.

However, if the CPU 11 determines in S4 that the total page count for cyan is not 0 (S4: NO), the CPU 11 judges that, while a housing of cartridge 100 into which the wireless IC tag 110 built is an approved product, either the cyan toner accommodated in the cartridge 100 is a non-approved product (refill toner) or that a cartridge accommodating approved cyan toner was temporarily removed and then remounted. In order to determine which case, in S6 the CPU 11 acquires the serial number of the MFP 10 from the toner data. In S7 the CPU 11 acquires the serial number of the MFP stored in the MFP serial number area 12a and determines whether the serial number of the MFP 10 acquired in S6 matches the serial number of the MFP 10 stored in the MFP serial number area 12a of the MFP 10.

If the two serial numbers do not match (S7: NO), then the CPU 11 judges that the serial number stored in the wireless IC tag 110 identifies a different MFP than the MFP 10 and that the cartridge 100 mounted in the MFP 10 was previously used in the different MFP. In other words, while the housing of the cartridge 100 conforms to an approved product, the cyan toner accommodated in the cartridge 100 is a non-approved product (refill toner). That is, the CPU 11 determines that the cartridge 100 is a non-approved product. Accordingly, the CPU 11 judges that the acquired toner data does not conform to the characteristics of the cyan toner accommodated in the cartridge 100 and advances to S10. However, if the CPU 11 determines that the two serial numbers match (S7: YES), the CPU 11 judges that the approved cartridge 100 accommodating the approved cyan toner was temporarily removed and then remounted. Accordingly, the CPU 11 advances to S8. As described above, through the processes of S3-S7, the CPU 11 determines whether or not the acquired toner data is suitable for characteristic of color toner contained in the cartridge 100. When the acquired toner data is not suitable, the

CPU 11 sets the non-approved product flags 131a to ON in S10. However, when the acquired toner data is suitable, the non-approved product flags 131a are set to OFF.

In S8 the CPU 11 acquires the first color profiles from the toner data and stores these profiles in the first color profile area 14d. In S9 the CPU 11 extracts the first calibration parameters for cyan from the toner data and stores these parameters in the cyan first calibration parameter area 14c1. In S11 the CPU 11 initializes the total page count for cyan to 0 in the cyan total page count area 14b1 and subsequently ends the mounting process of FIG. 6.

In the mounting process described above, the CPU 11 uses a device-specific serial number uniquely assigned to the MFP 10 to determine whether the acquired toner data conforms to the properties of the cyan toner accommodated in the cartridge 100. In this way, the CPU 11 can accurately determine whether the acquired toner data conforms to the properties of the cyan toner accommodated in the cartridge 100, without requiring any preparation of special data.

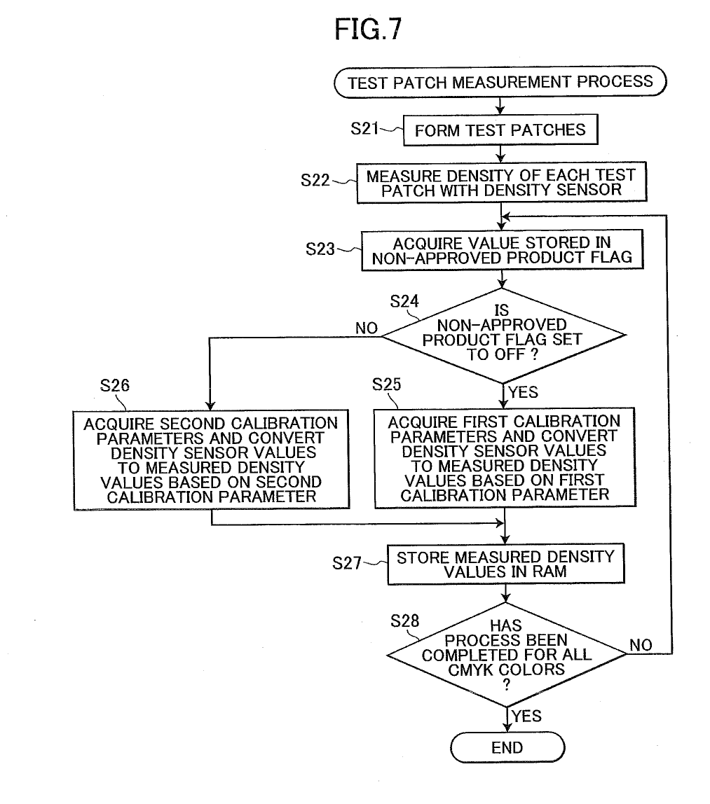

Next, a test patch measurement process will be described with reference to FIG. 7. In S21 at the beginning of the test patch measurement process, the CPU 11 controls the image forming unit 17 to form a plurality of test patches on the intermediate transfer member 30 at set density values (percentage values) as illustrated in FIG. 8(a). The test patches are formed for each of the CMYK colors at intervals of 10 percent from 0 percent to 100 percent (a total of 11 values for each color; a test patch is obviously not formed when the set value is 0 percent and is formed at the highest density when the set value is 100 percent).

In S22 the CPU 11 measures the density of each test patch with the density sensor 19. Specifically, the density sensor 19 emits light onto each test patch and measures the density of the test patch based on the amount of reflected light. FIG. 8(a) illustrates the process of S21 in which the density sensor 19 measures the density of each test patch. The CPU 11 can find relationships between the set values and measured densities measured by the density sensor 19 (referred to as “density sensor value”), as illustrated in the graph of FIG. 8(b), where the horizontal axis indicates the set value for each test patch and the vertical axis indicates the density sensor value. Since the amount of reflected light detected by the density sensor 19 lessens as the set density of the test patch rises, the density sensory value decreases as the set value of the test patch increases, as shown in FIG. 8(b).

In S23 the CPU 11 acquires the value stored in the cyan non-approved product flag 13a1. In S24 the CPU 11 determines whether the cyan non-approved product flag 13a1 is set to OFF. If the cyan non-approved product flag 13a1 is set to OFF (S24: YES), then the CPU 11 judges that the cartridge 100 is an approved product and that the cyan toner accommodated in the approved cartridge 100 is an approved product. Accordingly, in S25 the CPU 11 acquires the first calibration parameters for cyan from the cyan first calibration parameter area 14c1 and uses these parameters to convert the density sensor values to measured density values.

However, if the cyan non-approved product flag 13a1 is set to ON (S24: NO), then the CPU 11 determines that the cartridge 100 is a non-approved product and that the cyan toner accommodated in the cartridge 100 is a non-approved product. Accordingly, in S26 the CPU 11 acquires the second calibration parameters for cyan from the cyan second calibration parameter area 12b1 and uses these parameters to convert the density sensor values to measured density values.

In S27 the CPU 11 stores the measured density values in a prescribed area of the RAM 13 and in S28 determines whether the process in S23-S27 has been performed for each of the CMYK colors. If the process has not been completed for all CMYK colors (S28: NO), the CPU 11 returns to S23 and repeats the above process until all of the CMYK colors have been processed.

When the CPU 11 determines in S28 that the process of S23-S28 has been performed for each of the CMYK colors (S28: YES), the CPU 11 ends the test patch measurement process of FIG. 7.

Next, the method of converting the density sensor values to measured density values will be described. In steps S25 and S26, the CPU 11 calculates measured density values predicted for an image printed on paper based on the density sensor values for each of the CMYK colors, as illustrated in FIGS. 8(c) and 8(d). The first and second calibration parameters used for calculating the measured density values include a first function defined by f(x) and a second function defined by Lut(x′), as shown in FIG. 8(c), for each of the CMYK colors. Functions supplied from the manufacturer of the MFP 10 for calculating accurate measured density values are used as the first and second functions constituting the first calibration parameters. However, the first and second functions constituting the second calibration parameters are functions designed to calculate measured density values for generating a high-density calibration table described later. The first and second functions used in the first embodiment are functions capable of calculating measured density values similar to those calculated using the first calibration parameters.

The first function defined by f(x) serves to invert the slope of the density sensor values. The CPU 11 substitutes the density sensory values temporarily stored in the RAM 13 for “x” in the first function. The second function defined by Lut(x′) serves to calculate the measured density values predicted for the image when the image is printed on paper. The CPU 11 substitutes the value found by substituting x in the first function f(x) into x′ of the second function Lut(x′) to calculate the measured density value.

FIG. 8(d) shows the relationship between set values for each test patch, and measured density values calculated using the first and second functions, where the horizontal axis represents the set values for each test patch and the vertical axis represents the measured density values. Here, FIG. 8(d) shows relationships for the case using the first calibration parameters. While the density sensory values decrease as the set values for the text patches increase, as illustrated in FIG. 8(b), the measured density values calculated by applying the first function f(x) and the second function Lut(x′) described above to the density sensory values increase as the set values for the test patches increase. When the cyan toner accommodated in the cartridge 100 is a non-approved product, the CPU 11 uses the second calibration parameters to calculate relationships similar to those shown in FIG. 8(d). The relationships between set values for the test patches and measured density values shown in FIG. 8(d) are used to generate a calibration table.

While the density sensory values are converted to measured density values using the first and second functions in the preferred embodiment, this conversion may be performed using other functions (a single function, for example).

A printing process shown in FIG. 9 is executed by the CPU 11 when the user inputs a printing instruction. In S31 at the beginning of the printing process, the CPU 11 acquires the value stored in the cyan non-approved product flag 13a1. In S32 the CPU 11 determines whether the cyan non-approved product flag 13a1 is set to OFF.

If the cyan non-approved product flag 13a1 is set to OFF (S32: YES), the CPU 11 judges that the cyan toner accommodated in the cartridge 100 is an approved product and in S33 sets the calibration target values for cyan to the normal-density calibration target values stored in the cyan normal-density calibration target value area 12e1. However, if the cyan non-approved product flag 13a1 is set to ON (S32: NO), the CPU 11 judges that the cyan toner accommodated in the cartridge 100 is a non-approved product and in S34 sets the calibration target values to the high-density calibration target values for cyan stored in the cyan high-density calibration target value area 12c1.

In S35 the CPU 11 generates either a normal-density calibration table or a high-density calibration table for cyan using the measured density values for cyan stored in the prescribed area of the RAM 13 and the calibration target values set in S33 or S34.

Since the cyan non-approved product flag 13a1 is set to OFF when the normal-density calibration target values are set to the calibration target values (S32: YES), the measured density values stored in the RAM 13 were calculated using the first calibration parameters for cyan (S25 of FIG. 7). Accordingly, the normal-density calibration table for cyan is generated from the normal-density calibration target values and measured density values calculated using the first calibration parameters for cyan.

On the other hand, since the cyan non-approved product flag 13a1 is set to ON when the high-density calibration values are set as the calibration target values (S32: NO), the measured density values stored in the RAM 13 were calculated using the second calibration parameters (S26 of FIG. 7). Accordingly, the high-density calibration table for cyan is generated from the high-density calibration target values and the measured density values calculated using the second calibration parameters for cyan.

After generating the calibration table in S35, in S36 the CPU 11 determines whether the process in S31-S35 has been completed for each of the CMYK colors. If the process has not been completed for all of the CMYK colors (S36: NO), the CPU 11 returns to S31 and repeats the above process until all CMYK colors have been processed. However, when the CPU 11 determines that the process in S31-S35 has been performed for all CMYK colors (S36: YES), the CPU 11 advances to S37.

In the process of S35 described above, the CPU 11 sets separate calibration target values and creates separate calibration tables for each of the CMYK colors. For example, if the calibration target values for cyan are set to the normal-density calibration target values for cyan while the calibration target values for magenta, yellow, and black are set to the high-density calibration target values for magenta, yellow, and black, respectively, in S35 the CPU 11 generates a normal-density calibration table for cyan and high-density calibration tables for magenta, yellow, and black.

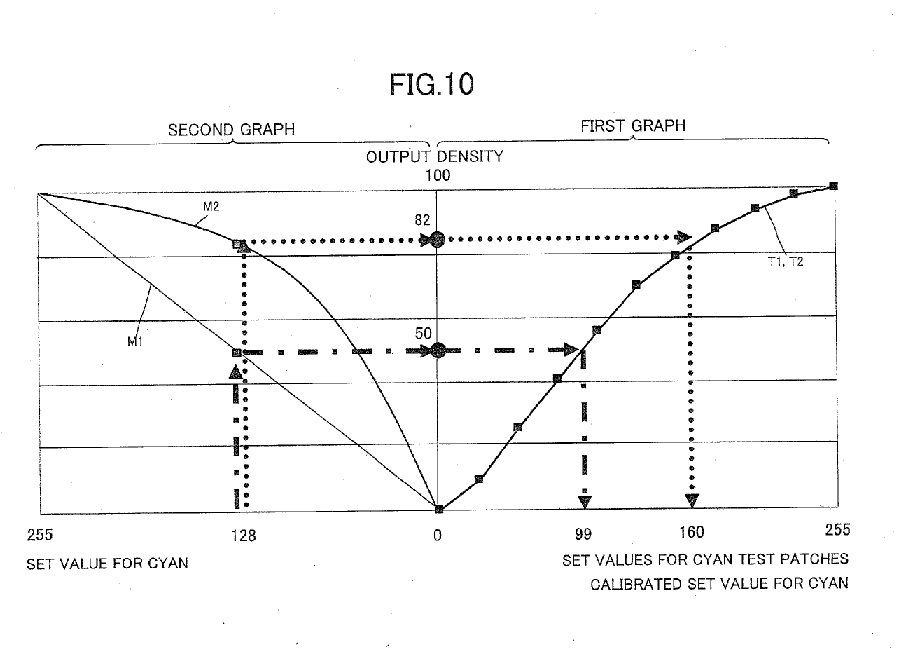

As described above, the CPU 11 generates either a normal-density calibration table or a high-density calibration table for each of the CMYK colors using the relationships between set values for the test patches and measured density values shown in FIG. 8(d). The process for generating both calibration tables will be described here with reference to FIG. 10. Since the method of generating calibration tables is the same for all of the CMYK colors, only the method of generating cyan calibration tables is used as an example in FIG. 10.

First the CPU 11 generates a first graph showing the relationship between the set values and measured density values for cyan test patches shown in FIG. 8(d). At this time, the CPU 11 converts the set values for cyan test patches (0-100%) to values between 0 and 255 and converts the measured density values for the cyan test patches to output densities. Here, “output densities” are found by normalizing the measured density values based on a maximum measured density value for the cyan test patches (see FIG. 8(d)) and converting these normalized values to values between 0 and 100. The output density indicates the predicted density of an image when the image is formed on paper.

In the following description, it will be assumed that the cyan measured density values calculated using the first calibration parameters for cyan (shown in FIG. 8(d)) and the cyan measured density values calculated using the second calibration parameters for cyan are the same for each set value in the first graph. That is, the following description will assume that the curve T1 indicating measured density values for cyan calculated using the first calibration parameters for cyan matches a curve T2 indicating measured density values for cyan calculated using the second calibration parameters for cyan. However, in fact the curves T1 and T2 normally will not match since they are found using different calibration parameters.

In the first graph of FIG. 10, the horizontal axis represents set values for cyan test patches, while the vertical axis represents output densities for cyan. After generating the first graph, the CPU 11 generates a second graph indicating calibration target values.

Here, the CPU 11 generates a line M1 indicating normal-density calibration target values for cyan when the cyan toner accommodated in the cartridge 100 is an approved product (S32: YES in FIG. 9), and generates a curve M2 indicating high-density calibration target values for cyan when the cyan toner is a non-approved product (S32: NO in FIG. 9).

Both the line M1 indicating normal-density calibration target values for cyan and the curve M2 indicating high-density calibration target values for cyan have been plotted in the second graph of FIG. 10.

The line M1 indicating the target values for normal-density calibration shows the relationship between CMYK values in data to be processed (CMYK data) and output densities, which relationship is expressed as a linear function. The curve M2 indicating the target values for high-density calibration shows the relationship between CMYK values in data to be processed and output densities, which relationship is expressed by a curvilinear function. In the second graph, the horizontal axis represents the C value in the CMYK values of the data being processed, while the vertical axis represents the output densities.

The process for generating a cyan calibration table will be described next for both cases in which the cyan toner accommodated in the cartridge 100 is an approved product and a non-approved product (i.e., the process for generating a normal and a high-density calibration table).

First, the process for generating the normal-density calibration table for cyan will be described. In this process, the CPU 11 first sets output densities for each C value between 0 and 255 using the line M1. For example, the CPU 11 sets the output density to 50 for a C value of 128 in the data being processed. Next, the CPU 11 uses the curve T1 to calculate calibration values C′ for calibrating the C values in order to produce the output densities calculated above. For example, if the determined output density is 50, the CPU 11 calibrates the C value of 128 to a C′ value of 99. By using the C′ value of 99 in place of the C value of 128, the CPU 11 can form a cyan image on paper having an output density of 50. By repeatedly calibrating C values to C′ values, the CPU 11 generates the normal-density calibration table for cyan to be used in calibrating C values to C′ values (as in the above example for calibrating 128 to 99).

Next, the process for generating the high-density calibration table for cyan will be described. In this process, the CPU 11 first sets output densities for each C value between 0 and 255 using the line M2. For example, the CPU 11 sets the output density to 82 for a C value of 128 in the data being processed. Next, the CPU 11 uses the curve T2 to calculate calibration values C′ for calibrating C values in order to produce the output densities calculated above. For example, if the target output density is 82, the CPU 11 calibrates the C value of 128 to a C′ value of 160. By using the C′ value of 160 in place of the C value of 128, the CPU 11 can form a cyan image on paper having an output density of 82. By repeatedly calibrating C values to C′ values, the CPU 11 generates the high-density calibration table for calibrating C values in the data being processed to C′ values (as in the above example for calibrating 128 to 160).

In the first embodiment, the curve M2 corresponding to each of the C, M, Y, and K colors that indicates target values for high-density calibration describes a convex curve having higher output densities than those of the line M1 indicating target values for normal-density calibration for the same color. In other words, the target values for high-density calibration are set to higher output densities than target values in normal-density calibration, excluding CMYK values near 0 or near 255. Hence, the high-density calibration table produced from the curve M2 calibrates the corresponding CMYK value to a C′M′Y′K′ value needed to generate a higher output density than the output density produced from the normal-density calibration table generated from the line M1.

Further, the curve M2 is set to a curvilinear function with which output densities change at a higher rate when the CMYK values are low values between 0 and 64. Hence, the high-density calibration table generated from the curve M2 can calculate C′M′Y′K′ values that produce output densities with a higher rate of change for low CMYK values than values calculated with the normal-density calibration table generated from the line M1.

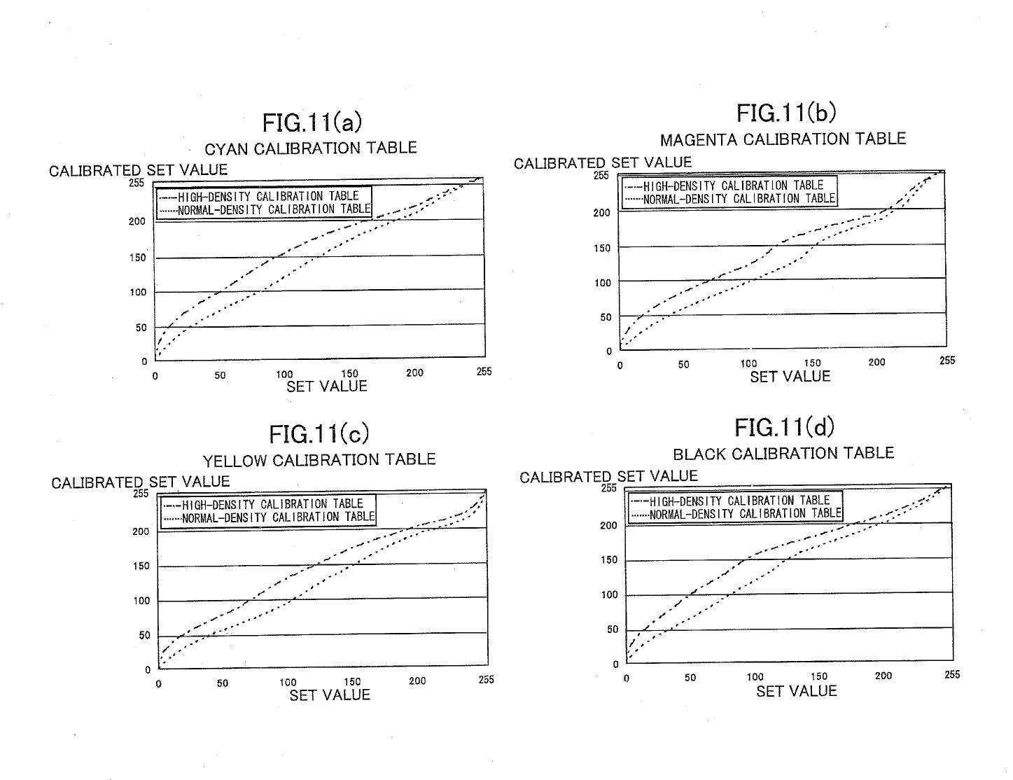

FIGS. 11(a) through 11(d) are graphs indicating values in a normal-density calibration table and a high-density calibration table for each of the colors cyan, magenta, yellow, and black. In each of the graphs shown in FIGS. 11(a)-11(d), the horizontal axis represents the corresponding CMYK value, while the vertical axis represents the corresponding C′M′Y′K′ value (calibration value).

As shown in FIGS. 11(a) through 11(d), except for CMYK values near 0 and near 255, the corresponding C′M′Y′K′ values are set to higher values in the corresponding high-density calibration table generated when the toner accommodated in the cartridge 100 is a non-approved product than in the corresponding normal-density calibration table generated when the toner accommodated in the cartridge 100 is an approved product. In this case, the density of the image formed on paper increases as the C′M′Y′K′ value increases. In other words, the CPU 11 generates image data by changing tone of pixels constituting the original image data in accordance with the high-density calibration table when the cartridge 100 is a non-approved product, the image having a density higher than an image formed based on the normal-density calibration table. Hence, an image with higher density can be formed on paper when the toner in the cartridge 100 is a non-approved product than when the toner is an approved product, thereby making the printed image more distinctly visible when the toner is a non-approved product.

Returning to the printing process of FIG. 9, in S37 the CPU 11 acquires RGB values for one pixel from the original image data. In S38 the CPU 11 converts the RGB values for the pixel to CMYK values. The CPU 11 performs this conversion using the first color profiles (3D lookup tables) when first color profiles are stored in the first color profile area 14d. However, when first color profiles are not stored in the first color profile area 14d, the CPU 11 generates 3D lookup tables using the second color profiles stored in the second color profile area 12d and uses these 3D lookup tables to convert RGB values to CMYK values.

In S39 the CPU 11 executes the calibration process. Specifically, the

CPU 11 calculates C′M′Y′K′ values (calibration values) for each of the CMYK colors by calibrating the CMYK values found in S38 using the normal-density calibration tables or the high-density calibration tables generated in S35. In S40 the CPU 11 executes a binarization process. In this process, the CPU 11 applies dither patterns stored in a prescribed area of the ROM 12 to the C′M′Y′K′ values in order to convert data for one pixel to binary data indicating either ON or OFF.

In S41 the CPU 11 determines whether the process in S37-S40 has been executed for all pixels in the original image data. If this process has not been executed for all pixels (S41: NO), the CPU 11 returns to S37 and repeats the above process. However, when the process has been completed for all pixels (S41: YES), in S42 the CPU 11 supplies processed image data (the binary data) to the image forming unit 17, and controls the image forming unit 17 to form an image on paper based on the processed image data (the binary data).

In S43 the CPU 11 increments by one the total page counts stored in the total page count area 14b corresponding to colors used in the printing process. For example, if only black toner accommodated in the cartridge 100 is used in the printing process of S42, the CPU 11 increments only the total page count stored in the black total page count area 14b4, but does not increment the total page counts stored in the total page count areas 14b1-14b3 for the other colors.

In S44 the CPU 11 determines whether the processed image data has been printed the number of times specified by the user, i.e., whether the printing process has been completed for the total number of copies specified by the user. If the total number of copies has not been printed (S44: NO), the CPU 11 repeats steps S42 and S43. However, if the total number of copies has been printed (S44: YES), in S45 the CPU 11 copies the total page counts stored in the total page count area 14b to the total page count area 114b of the wireless IC tag 110, and subsequently ends the printing process of FIG. 9.

As described above, when the MFP 10 of the control system 1 acquires toner data from the wireless IC tag 110 built in the cartridge 100 and determines that the toner accommodated in the mounted cartridge 100 is an approved product based on this toner data, the MFP 10 generates normal-density calibration table based on the measured density values calculated using the first calibration parameters obtained from the cartridge 100 and the target values for normal-density calibration. The MFP 10 then performs a calibration process using the normal-density calibration table. However, if the MFP 10 cannot acquire toner data from a wireless IC tag 110 or if the toner data acquired from the wireless IC tag 110 does not conform to toner accommodated in the cartridge 100, the MFP 10 determines that the toner accommodated in the cartridge 100 is a non-approved product. Accordingly, the MFP 10 generates a high-density calibration table from the measured density values calculated using the predetermined second calibration parameters and the target values for high-density calibration and executes the calibration process using this high-density calibration table.

This high-density calibration table sets higher C′M′Y′K′ values for CMYK values than the normal-density calibration table, except for CMYK values near 0 or near 255. Accordingly, when the MFP 10 determines that the cartridge 100 is a non-approved product, the MFP 10 can increase the density of images formed on paper from the density used when the cartridge 100 is an approved product. As a result, the printed images are more distinctly visible, even when the toner accommodated in the cartridge 100 is a non-approved product.

In the MFP 10 of the control system 1, second calibration parameters are stored in the storage area 12b and target values for high-density calibration are stored in the storage area 12c, and the MFP 10 generates high-density calibration tables based on these data when the cartridge 100 (toner accommodated in the cartridge 100) is determined to be a non-approved product. Accordingly, the MFP 10 can reliably form images on paper with a higher density than when the cartridge 100 is determined to be an approved product.

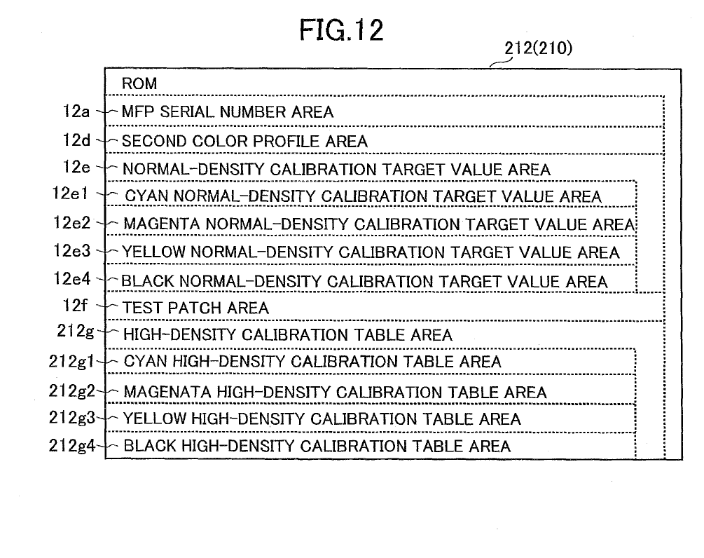

Next, a second embodiment of the present invention will be described with reference to FIGS. 12 through 14. An MFP 210 according to the second embodiment differs from the MFP 10 according to the first embodiment described with reference to FIGS. 1 through 11 in that steps in the test patch measurement process and printing process have been partially modified. In the MFP 210, a ROM 212 is provided in place of the ROM 12 shown in FIG. 2. The remaining structure of the MFP 210 and processes executed by the MFP 210 are identical to those described in the first embodiment. In addition, the wireless IC tag 110 in the second embodiment is identical to that in the first embodiment. In the following description of the second embodiment, only variations from the MFP 10 will be described.

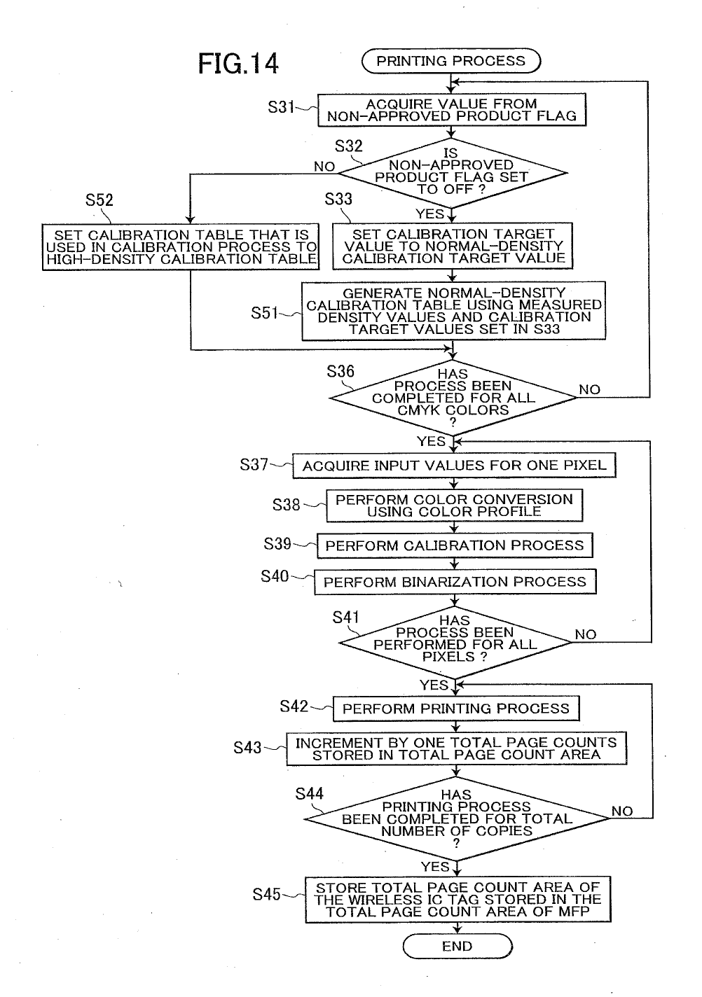

As shown in FIG. 12, the ROM 212 includes the MFP serial number area 12a, the second color profile area 12d, the normal-density calibration target value area 12e, the test patch area 12f, and a high-density calibration table area 212g. The high-density calibration table area 212g stores high-density calibration tables in advance. Upon determining that toner accommodated in the cartridge 100 is a non-approved product in the second embodiment, the MFP 210 executes the calibration process (S39 of FIG. 14) using this pre-stored high-density calibration table. Accordingly, the CPU 11 of the MFP 210 does not need to generate a high-density calibration table using the second calibration parameters and target values for high-density calibration. Therefore, the second calibration parameter area 12b and high-density calibration target value area 12c are not provided on the ROM 212.

The high-density calibration table area 212g stores high-density calibration tables (not shown) similar to those shown in FIG. 11 that have been prepared by the manufacturer for each of the CMYK colors. Specifically, high-density calibration tables for cyan, magenta, yellow, and black are respectively stored in the storage areas 212g1, 212g2, 212g3, and 212g4. These high-density calibration tables are configured to convert CMYK values in data being processed to higher C′M′Y′K′ values than those produced from the normal-density calibration tables used when the cartridge 100 is an approved product.

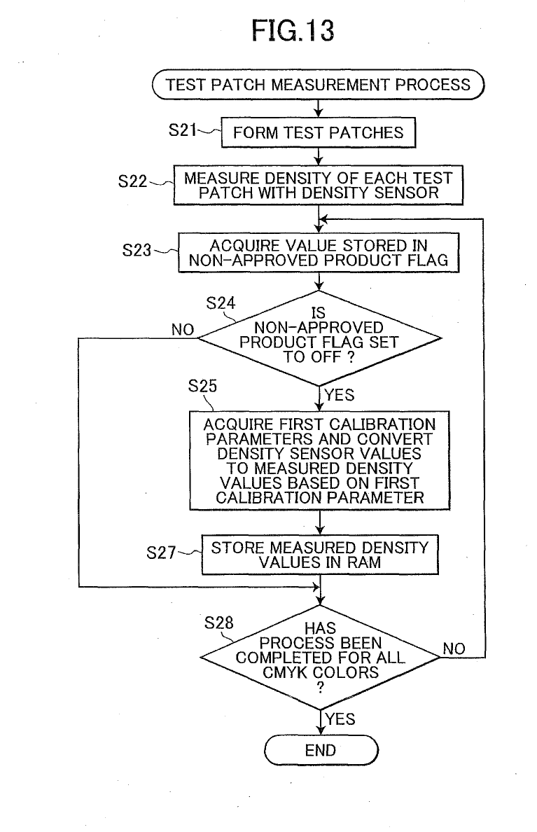

A test patch measurement process shown in FIG. 13 according to the second embodiment is same process as the test patch measurement process according to the first embodiment shown in FIG. 7, except that the test patch measurement process according to the second embodiment does not include the process of S26. Further, in this test patch measurement process according to the second embodiment, when the non-approved product flag 13a is set to ON, the CPU 11 uses the high-density calibration table that is prepared in the high-density calibration table area 212g without creating a calibration table based on the measured densities. Therefore, the CPU 11 does not perform the process of S27 when the non-approved product flag 13a is set to ON.

Specifically, if the cyan non-approved product flag 13a1 is set to ON (S24: NO), then the CPU 11 determines that the cyan toner accommodated in the cartridge 100 is a non-approved product and in S28 determines whether the process in S23-S27 has been performed for each of the CMYK colors.

As described above, the CPU 11 does not acquire the measured density values when the CPU 11 determines that the toner is a non-approved product because the high-density calibration tables are prepared in the high-density calibration table area 212g and used for calibration.

Next, a printing process executed by the CPU 11 of MFP 210 according to the second embodiment will be described with reference to FIG. 14. The printing process shown in FIG. 14 is same process as the printing process according to the first embodiment shown in FIG. 9, except that the printing process according to the second embodiment includes new processes of S51 and S52 and does not include the processes of S34 and S35.

In S31 at the beginning of the printing process, the CPU 11 acquires the value stored in the cyan non-approved product flag 13a1. In S32 the CPU 11 determines whether the cyan non-approved product flag 13a1 is set to OFF. If the cyan non-approved product flag 13a1 is set to OFF (S32: YES), the CPU 11 determines that the cartridge 100 is an approved product and that the cyan toner accommodated in the cartridge 100 is an approved product and in S33 sets the calibration target values for cyan to the normal-density calibration target values stored in the cyan normal-density calibration target value area 12e1. In S51 the CPU 11 generates a normal-density calibration table for cyan using the measured density values for cyan stored in the prescribed area of the RAM 13 and the calibration target values set in S33.

However, if the cyan non-approved product flag 13a1 is set to ON (S32: NO), the CPU 11 judges that the cartridge 100 is a non-approved product and that the cyan toner accommodated in the cartridge 100 is a non-approved product and in S52 sets the calibration table that is used in the calibration process of S39 to the high-density calibration table for cyan stored in the cyan high-density calibration table area 212g1.

After generating the normal-density calibration table in S51 or setting the high-density calibration table in S52, in S36 the CPU 11 determines whether the process in S31-S35 has been completed for each of the CMYK colors. The remaining process is same as that in the first embodiment shown in FIG. 9.

As described above, when the MFP 210 of the second embodiment determines that the toner accommodated in the cartridge 100 is a non-approved product, rather than generating high-density calibration tables as is performed by the MFP 10 of the first embodiment, the MFP 210 executes the calibration process using the high-density calibration tables stored in the high-density calibration table area 212g. Hence, the MFP 210 can begin the calibration process more quickly than the MFP 10 of the first embodiment upon determining that the toner is a non-approved product, since the MFP 10 must generate the high-density calibration tables.

Further, the MFP 210 can print an image having a higher density when the cartridge 100 is determined to be a non-approved product than when the cartridge 100 is determined to be an approved product, as in the first embodiment.

Further, the MFP 210 creates normal-density calibration tables using the measured density values and target values for normal-density calibration when determining that toner accommodated in the cartridge 100 is an approved product. Accordingly, the MFP 210 can accurately calculate C′M′Y′K′ values (calibration values) for the data being processed in the calibration process of S39.

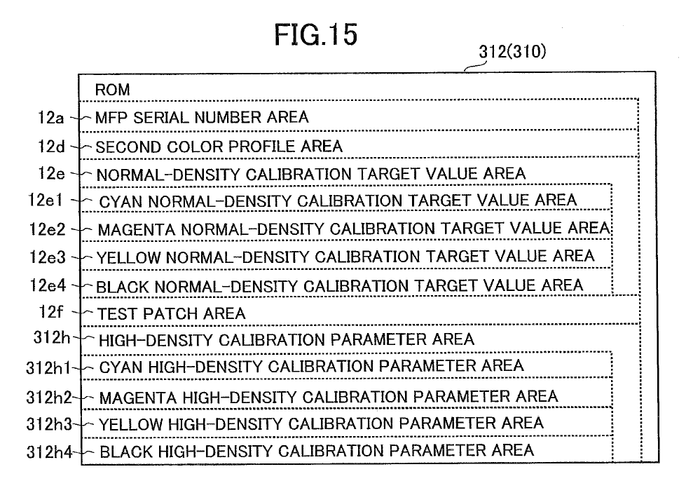

Next, a third embodiment of the present invention will be described with reference to FIGS. 15 through 18. An MFP 310 according to the third embodiment differs from the MFP 10 according to the first embodiment described with reference to FIGS. 1 through 11 in that steps in the test patch measurement process and printing process have been partially modified. Further, the MFP 310 includes a ROM 312 shown in FIG. 15 in place of the ROM 12 shown in FIG. 2. The remaining structure of the MFP 310 and processes executed by the MFP 310 are identical to those described in the first embodiment. In the following description of the third embodiment, only variations from the MFP 10 will be described.

As shown in FIG. 15, the ROM 312 includes the MFP serial number area 12a, the second color profile area 12d, the normal-density calibration target value area 12e, the test patch area 12f, and a high-density calibration parameter area 312h.

The high-density calibration parameter area 312h stores high-density calibration parameters that are used when the toner accommodated in the cartridge 100 mounted on the MFP 310 is a non-approved product. The high-density calibration parameters are provided for each of the colors C, M, Y, and K. The high-density calibration parameter area 312h has individual areas 312h1, 312h2, 312h3, and 312h4 for respectively storing the high-density calibration parameters for cyan, magenta, yellow, and black.

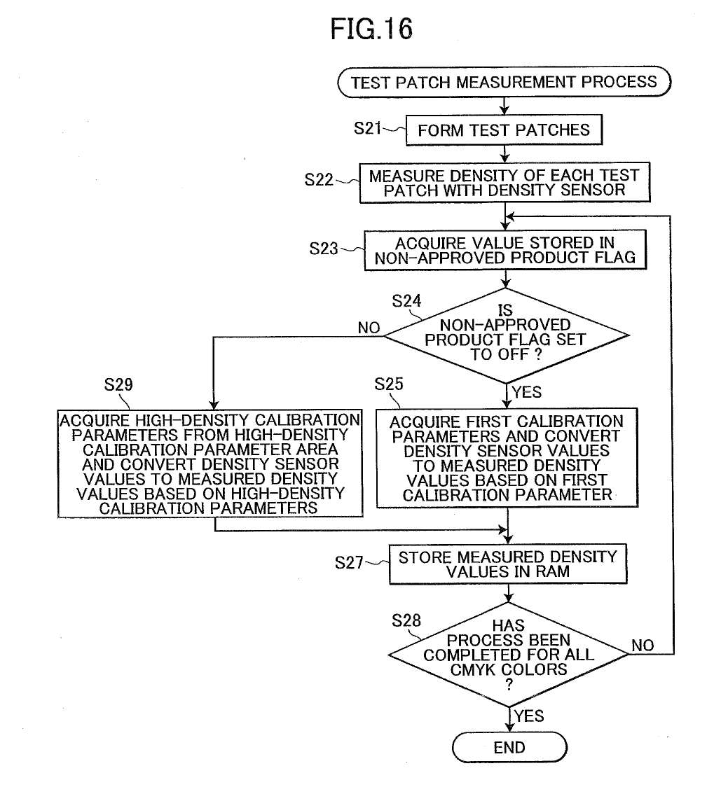

A test patch measurement process shown in FIG. 16 according to the third embodiment is same process as the test patch measurement process according to the first embodiment shown in FIG. 7, except that the process of S29 is included in place of the process of S26.

If the cyan non-approved product flag 13a1 is set to ON (S24: NO), then the CPU 11 determines that the cyan toner accommodated in the cartridge 100 is a non-approved product. Accordingly, in S29 the CPU 11 of MFP 310 acquires the high-density calibration parameters for cyan from the cyan high-density calibration parameter area 312h1 and uses these parameters to convert the density sensor values to measured density values.

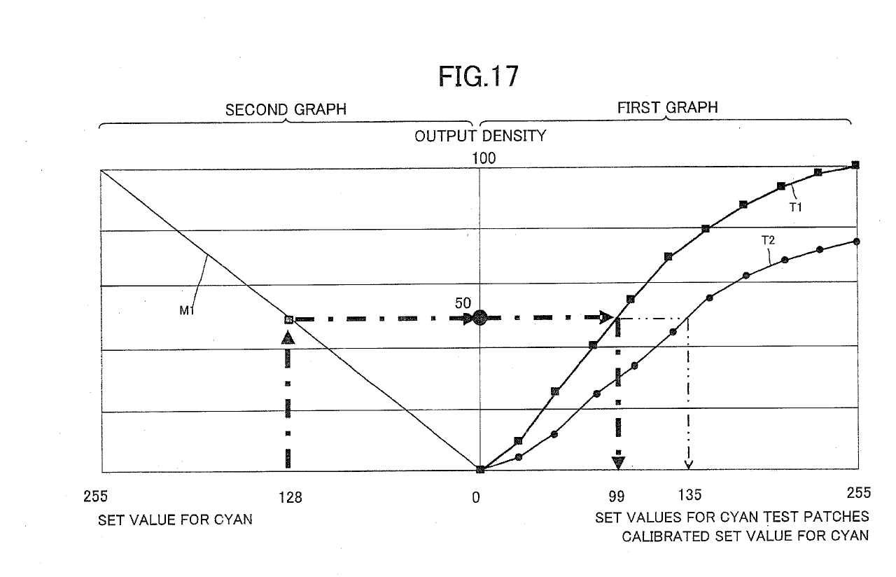

Here, the measured density values calculated using the first calibration parameters and the measured density values calculated using the high-density calibration parameters will be described with reference to the first graph in FIG. 17. As shown in FIG. 17, a curve T1 indicating measured density values calculated using the first calibration parameters, and a curve T2 indicating measured density values calculated using the high-density calibration parameters have been plotted in the first graph, where the horizontal and vertical axes are identical to those in the first graph of FIG. 10.

As is clear from the first graph in FIG. 17, the curve T2 indicating measured density values calculated from the high-density calibration parameters has a gentler slope (a slope with a smaller value) than that of the curve T1 indicating measured density values calculated from the first calibration parameters. Accordingly, the measured density values calculated using the high-density calibration parameters are smaller values than the measured density values calculated using the first calibration parameters for each set value.

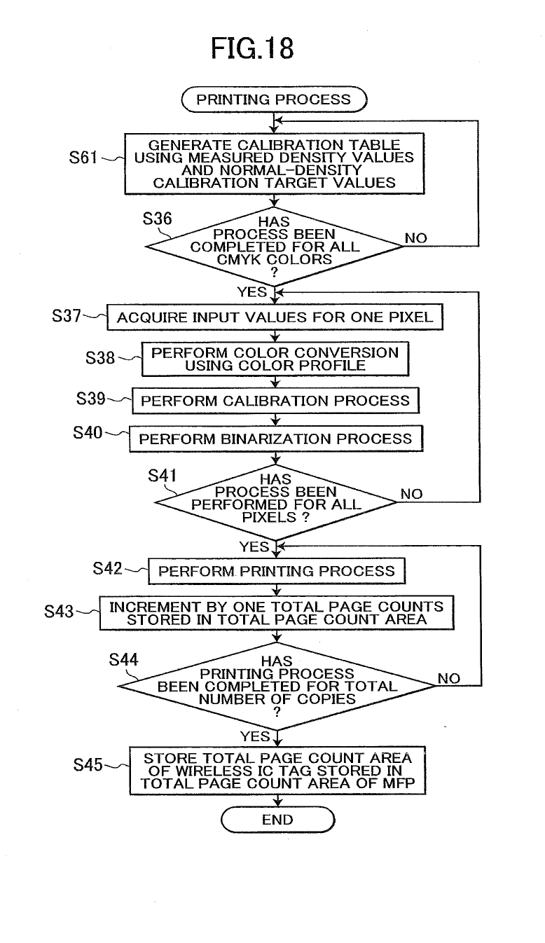

Next, a printing process executed by the CPU 11 of MFP 310 according to the third embodiment will be described with reference to FIG. 18. The printing process shown in FIG. 18 is same process as the printing process according to the first embodiment shown in FIG. 9, except that the printing process according to the third embodiment includes new process of S61 instead of the processes of S31-S35 in FIG. 9.

In S61 at the beginning of the printing process, the CPU 11 generates calibration table for cyan using the measured density values for cyan stored in the prescribed area of the RAM 13 and the normal-density calibration target values stored in the cyan normal-density calibration target value area 12e1.

A method for generating the calibration table in S61 will be described with reference to FIG. 17. First, the CPU 11 generates the first graph by plotting the measured density values stored in a prescribed area of the RAM 13. Here, the CPU 11 plots the curve T1 if the measured density values stored in the prescribed area of the RAM 13 are measured density values calculated using the first calibration parameters, and plots the curve T2 if the values are measured density values calculated using the high-density calibration parameters.

Next, the CPU 11 generates the line M1 by plotting the target values for normal-density calibration stored in the cyan normal-density calibration target value area 12e1 in the second graph. And then, the CPU 11 generates a calibration table using either the curve T1 or the curve T2, and the line M1.

Here, the process for generating a cyan calibration table will be described for the case of the curve T1 plotted in the first graph, i.e., the case in which the measured density values stored in the prescribed area of the RAM 13 were calculated using the first calibration parameters. First, the CPU 11 sets output densities for each of the C values from 0 to 255 using the line M1. For example, for the C value of 128 in the data being processed, the CPU 11 sets an output density of 50. Next, the CPU 11 calculates calibration values C′ for calibrating the C values in order to produce the output densities determined above using the curve T1. For example, if the output density is 50, the CPU 11 calibrates a C value of 128 to a C′ value of 99. By repeatedly calibrating C values to C′ values in this way, the CPU 11 generates a cyan calibration table for calibrating C values in the target data to C′ values (as in the example of calibrating 128 to 99). This calibration table is a normal-density calibration table similar to the normal-density calibration table shown in FIG. 11.

Next, the process for generating a cyan calibration table will be described for the case of the curve T2 plotted in the first graph, i.e., when the measured density values stored in the prescribed region of the RAM 13 were calculated using the high-density calibration parameters. First, the CPU 11 sets output densities for each of the C values from 0 to 255 using the line M1. For example, when the C value of the data being processed is 128, the CPU 11 sets an output density of 50. Next, the CPU 11 calculates calibration values C′ for calibrating the C values in order to produce the above output values using the curve T2. For example, if the output density is 50, the CPU 11 calibrates the C value of 128 to a C′ value of 135. By repeatedly calibrating C values to C′ values in this way, the CPU 11 generates a cyan calibration table for calibrating C values in the target data to C′ values (as in the example of calibrating 128 to 135). This calibration table is a high-density calibration table similar to the high-density calibration table shown in FIG. 11.

As described above, when the C value of the data being processed is 128, the CPU 11 sets the C′ value calibrated using the curve T2, which has a gentler (smaller) slope than that of the curve T1, to 135, which is a higher value the C′ value of 99 calibrated using the curve T1. Thus, the output density, i.e., the density of the image formed on paper, is higher for higher values of C′M′Y′K′. As in the example shown in FIG. 11, a high-density calibration table generated using the curve T2 calibrates the

CMYK values to C′M′Y′K′ values that produce higher output densities than those produced from a normal-density calibration table generated from the curve T1.

Returning to FIG. 18, in S61 the CPU 11 creates a separate calibration table for each of the CMYK colors, as described above. Accordingly, the CPU 11 generates a normal-density calibration table for cyan similar to the one shown in FIG. 11 when the measured density values for cyan stored in the prescribed area of the RAM 13 were calculated using the first calibration parameters, and generates high-density calibration tables for magenta, yellow, and black similar to those shown in FIG. 11 when the measured density values for magenta, yellow, and black stored in the prescribed area of the RAM 13 were calculated using the high-density calibration parameters.

As described above, the MFP 310 according to the third embodiment uses measured density values calculated using high-density calibration parameters (measured density values that are smaller for each set value than the measured density values calculated using the first calibration parameters) to generate a high-density calibration table, such as that shown in FIG. 11 for colors of toner accommodated in the cartridge 100 that are determined to be non-approved products, and executes the calibration process using the high-density calibration table. As with the MFP 10 according to the first embodiment, the MFP 310 can form images on paper with higher densities for colors of toner determined to be non-approved products than the densities produced with colors of toner determined to be approved products.

The MFP 310 also has high-density calibration parameters stored in the high-density calibration parameter area 12h. Hence, when the cartridge 100 is determined to be a non-approved product, the MFP 310 can generate a high-density calibration table for reliably forming images on paper at a higher density than that of images in colors of toner determined to be an approved product.

Further, when the cartridge 100 is determined to be an approved product, in other words, when toner accommodated in the cartridge 100 is determined to be an approved product, the MFP 310 generates a normal-density calibration table similar to that shown in FIG. 11 using measured density values that were calculated with the first calibration parameters, and executes the calibration process using this normal-density calibration table. Thus, the MFP 310 can accurately calculate C′M′Y′K′ values (calibration values) in the calibration process.

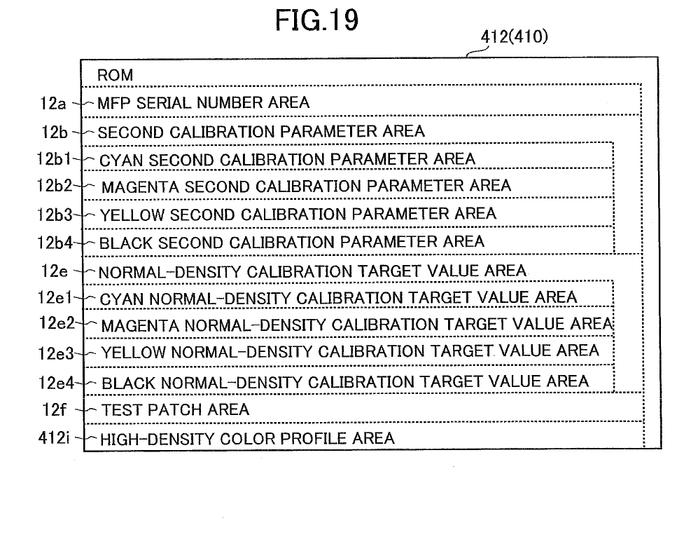

Next, a fourth embodiment of the present invention will be described with reference to FIGS. 19 through 23. An MFP 410 according to the fourth embodiment differs from the MFP 10 according to the first embodiment described with reference to FIGS. 1 through 11 in that steps in the test patch measurement process and printing process have been partially modified. Further, in the MFP 310, a ROM 412 shown in FIG. 15 is provided in place of the ROM 12 shown in FIG. 2. The remaining structure of the MFP 410 and processes executed by the MFP 410 are identical to those described in the first embodiment. In the following description of the third embodiment, only variations from the MFP 10 will be described.

As shown in FIG. 19, the ROM 412 includes the MFP serial number area 12a, the second calibration parameter area 12b, the normal-density calibration target value area 12e, the test patch area 12f, and a high-density color profile area 412i.

The high-density color profile area 412i stores high-density color profiles for converting RGB values of pixels in original image data to higher CMYK values than when using the first color profiles. The high-density color profiles are used when at least one of the colors of toner accommodated in the cartridge 100 is determined to be a non-approved product.

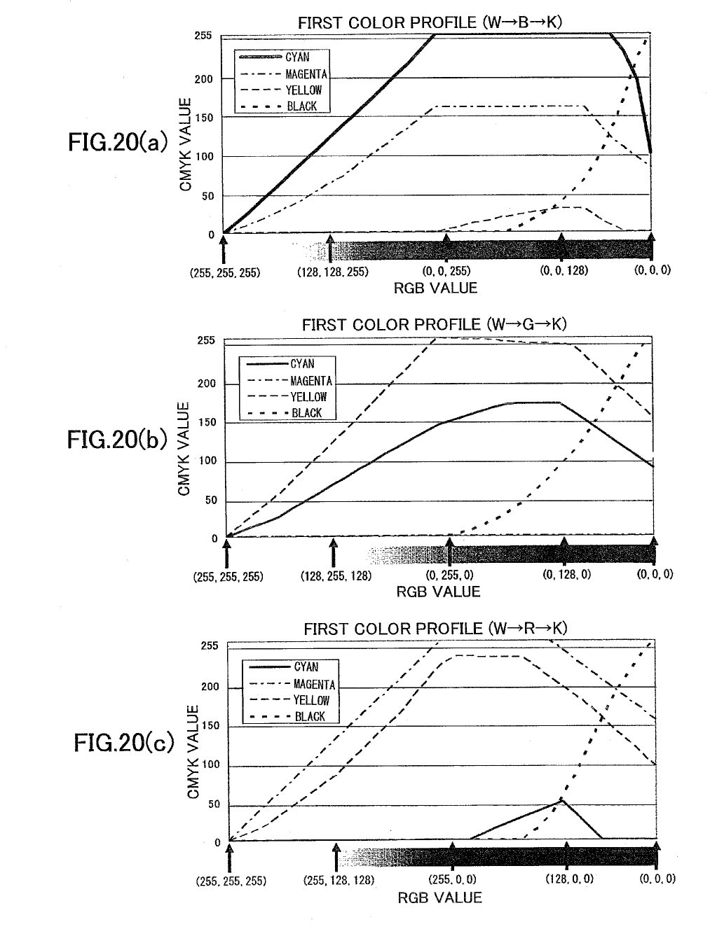

FIGS. 20(a) through 20(c) show properties of the first color profiles stored in the first color profile area 14d, where the horizontal axis of each graph represents one of the RGB values of the pixels in the original image data and the vertical axis represents the corresponding CMYK values. The graph in FIG. 20(a) shows a case of converting RGB values to CMYK values according to the color changes white (W)→blue (B)→black (K). The graph in FIG. 20(b) shows a case of converting RGB values to CMYK values according to the color changes white (W)→green (G)→black (K). The graph in FIG. 20(c) shows a case of converting RGB values to CMYK values according to the color changes white (W)→red (R)→black (K). When the CPU 11 determines that all toner accommodated in the cartridge 100 are approved products, the CPU 11 converts RGB values for pixels in the original image data to CMYK values using the first color profiles shown in FIGS. 20(a)-20(c).

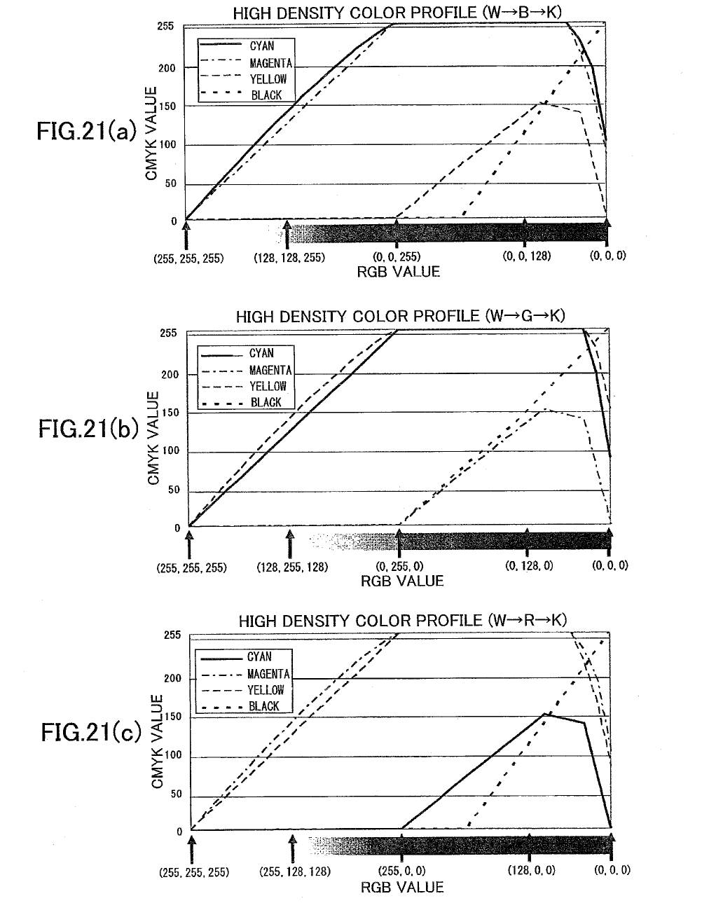

FIGS. 21(a)-21(c) show properties of the high-density color profiles stored in the high-density color profile area 12i. FIGS. 21(a)-21(c) correspond to FIGS. 20(a)-20(c). When the CPU 11 determines that toner accommodated in the cartridge 100 for even one color is a non-approved product, the CPU 11 converts the RGB values for pixels in the original image data to CMYK values using the high-density color profiles shown in FIGS. 21(a)-21(c).

As is clear by comparing graphs in FIGS. 21(a)-21(c) to those in FIGS. 20(a)-20(c), RGB values are set to higher CMYK values in the high-density color profiles of FIG. 21 for most RGB values, excluding those values near 0 or near 255. Hence, the CPU 11 can convert RGB values in pixel data to higher CMYK values using the high-density color profiles than when using the first color profiles.

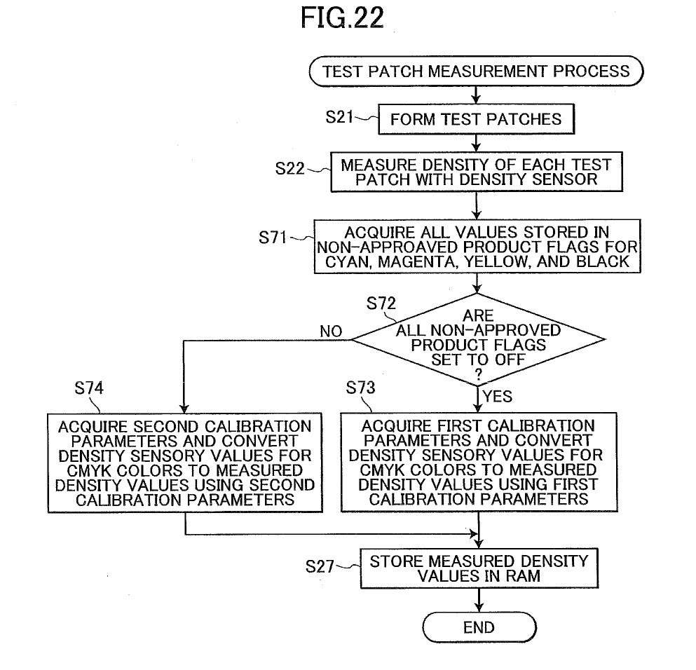

FIG. 22 is a flowchart illustrating steps in the test patch measurement process executed by the CPU 11 of the MFP 410. The process in FIG. 22 replaces steps S23-S26 and S28 in FIG. 7 with steps S71-S74, while the remaining steps are identical to those in FIG. 7.

In S71 of FIG. 22, the CPU 11 acquires each value stored in the non-approved product flags 13a1-13a4 for cyan, magenta, yellow, and black. In S72 the CPU 11 determines whether all of the non-approved product flags 13a1-13a4 are set to OFF.

If all of the non-approved product flags 13a1-13a4 are set to OFF (S72: YES), the CPU 11 judges toner in all colors accommodated in the cartridge 100 to be approved products. Therefore, in S73 the CPU 11 acquires the first calibration parameters extracted from the toner data, i.e., the first calibration parameters for each of the CMYK colors stored in the first calibration parameter area 14c and uses these first calibration parameters to convert density sensory values for the CMYK colors to measured density values.

However, if the CPU 11 determines that even one of the non-approved product flags 13a1-13a4 is set to ON (S72: NO), the CPU 11 judges that toner in at least one of the colors accommodated in the cartridge 100 is a non-approved product. Accordingly, in S74 the CPU 11 acquires second calibration parameters for each of the CMYK colors stored in the second calibration parameter area 12b and uses these parameters to convert density sensory values for each of the CMYK colors to measured density values. After completing the process in either S73 or S74, the CPU 11 advances to S27.

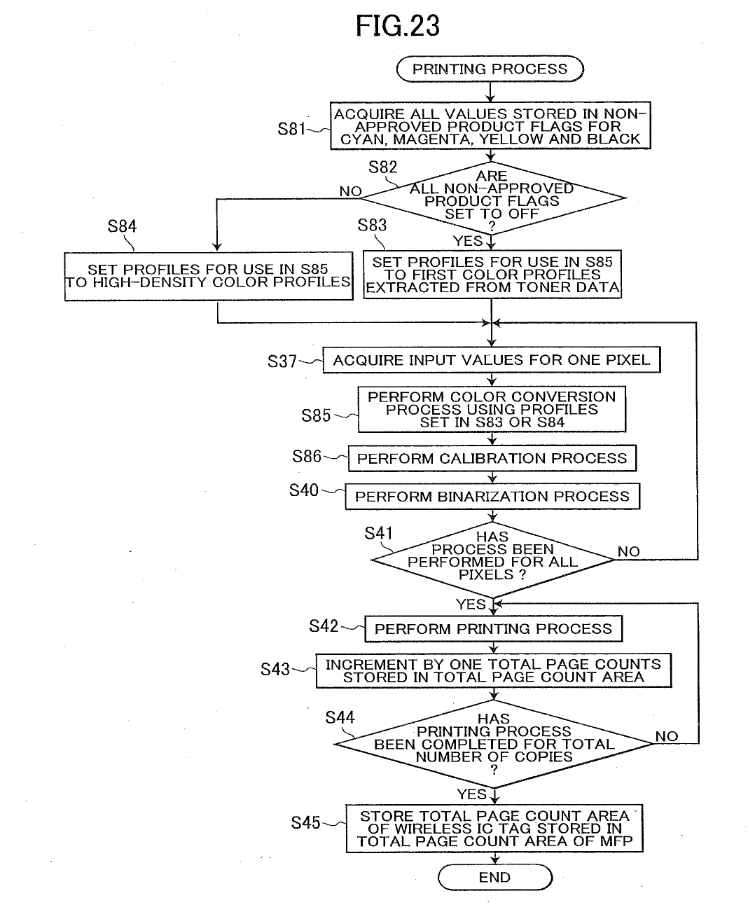

FIG. 23 is a flowchart illustrating steps in a printing process executed by the CPU 11 of the MFP 410. The process in FIG. 23 is similar to that in FIG. 9, except that the steps S31-S36, S38, and S39 are replaced with the steps S81-S86.

In S81 at the beginning of the printing process in FIG. 23, the CPU 11 acquires all values stored in the non-approved product flags 13a1-13a4. In S82 the CPU 11 determines whether all of the non-approved product flags 13a1-13a4 are set to OFF.

If the CPU 11 determines that all non-approved product flags 13a1-13a4 are set to OFF (S82: YES), the CPU 11 judges that the toner accommodated in the cartridge 100 for all colors are approved products. Accordingly, in S83 the CPU 11 sets the profiles for use in S85 to the first color profiles extracted from the toner data and stored in the first color profile area 14d (see FIG. 20).

However, if the CPU 11 determines that even one of the non-approved product flags 13a1-13a4 is set to ON (S82: NO), the CPU 11 judges that toner of at least one color accommodated in the cartridge 100 is a non-approved product. Accordingly, in S84 the CPU 11 sets the profiles for use in S85 to the high-density color profiles stored in the high-density color profile area 412i.

After completing one of the processes in S83 or S84, the CPU 11 executes the process in S37 described in the first embodiment and in S85 executes a color conversion process using the profiles set in either S83 or S84. Specifically, in S85 the CPU 11 calculates CMYK values using the first color profiles (see FIG. 20) if the profiles were set in S83 and using the high-density color profiles (see FIG. 21) if the profiles were set in S84. In other words, the CPU 11 prepares the color conversion tables using the color profile set in either S83 or S84.

If the CPU 11 executed the process in S83, in S86 the CPU 11 generates calibration tables for each of the CMYK colors using the measured density values for the respective colors calculated according to the first calibration parameters and the target values for normal-density calibration of the corresponding colors stored in the normal-density calibration target value area 12e and uses these calibration tables to calibrate CMYK values calculated using the first color profiles to C′M′Y′K′ values.

However, if the CPU 11 executed the process in S84, in S86 the CPU 11 generates calibration tables for each of the CMYK colors using the measured density values for the respective colors calculated according to the second calibration parameters and the target values for normal-density calibration of the corresponding colors stored in the normal-density calibration target value area 12e and uses these calibration tables to calibrate the CMYK values calculated using the high-density color profiles to C′M′Y′K′ values.

As is clear from the profiles shown in FIGS. 20(a) though 21(c), RGB values are converted to higher CMYK values when using the high-density color profiles than when using the first color profiles. Accordingly, the CMYK values calculated in S85 are higher when the high-density color profiles are used than when the first color profiles are used. Consequently, the C′M′Y′K′ values calculated in the calibration process of S86 are relatively higher when using the high-density color profiles than when using the first color profiles.

As described above, the MFP 410 according to the fourth embodiment calculates CMYK values in S85 using high-density color profiles after determining that at least one of the toner colors accommodated in the cartridge 100 is a non-approved product. Accordingly, the MFP 410 can calculate higher C′M′Y′K′ values in S86 when determining that at least one of the colors of toner is a non-approved product than when determining that all of the colors of toner are approved products, and can thereby increase the density of the image formed on paper.

Further, high-density color profiles are stored in the high-density color profile area 412i of the ROM 412 in the MFP 410 in advance. Hence, when the CPU 11 of the MFP 410 determines that at least one of the colors of toner accommodated in the cartridge 100 is a non-approved product, the MFP 410 does not need to generate high-density color profiles. Therefore, the MFP 410 can begin executing the color conversion process in S85 of FIG. 23 more quickly than when having to generate high-density color profiles.

While the invention has been described in detail with reference to the embodiments thereof, it would be apparent to those skilled in the art that various changes and modifications may be made therein without departing from the spirit of the invention.

In the mounting process of FIG. 6 described in the first, second, third, and fourth embodiments, when the CPU 11 determines that toner data was returned from the wireless IC tag 110 (S2: YES), the CPU 11 acquires the total page count for one color in the toner data (S3) and determines whether the total page count is 0 (S4). If the CPU 11 determines that the total page count is 0 (S4: YES), the CPU 11 determines that toner of the current color accommodated in the cartridge 100 is an unused approved product and that the acquired data conforms to the properties of the toner. However, the present invention is not limited to this configuration. Specifically, after determining that toner data was returned in the mounting process, the CPU 11 may skip steps S3-S7, judging that the toner accommodated in the cartridge 100 is an approved product and that the acquired toner data conforms with the properties of the toner accommodated in the cartridge 100. In this way, the CPU 11 can more quickly determine whether the toner in the cartridge 100 is an approved product.

Further, a data processing device communicable with the MFP 10, 210, 310, or 410 as described above, such as a personal computer, may perform to the mounting process, the test patch measurement process, and the printing process instead of the MFP 10, 210, 310, or 410. This data processing device includes the CPU 11, the ROM 12, 212, 312, or 412, the RAM 13, and the flash memory 14. In S42, the CPU 11 may supply converted image data to the MFP. With this data processing system, it is possible to reduce processing load of the MFP.

In the mounting process of the first, second, third, and forth embodiments described above with reference to FIG. 6, the CPU 11 acquires the serial number of the MFP 10 from the toner data (S6) in order to determine whether a cartridge 100 accommodating approved toner was temporarily removed and remounted, and determines whether the acquired serial number matches the serial number of the MFP 10 stored in the MFP serial number area 12a (S7), but the present invention is not limited to this configuration. For example, the CPU 11 may skip S6 of the mounting process and perform the following process as S7. Specifically, after skipping S6, in S7 the CPU 11 determines whether each of the total page counts for cyan, magenta, yellow, and black acquired from the toner data in S3 matches each of the corresponding total page counts for the same colors stored in the total page count area 14b. If all page counts match (S7: YES), the CPU 11 may judge that a cartridge 100 accommodating approved toner was temporarily removed and then remounted.

Alternatively, the CPU 11 may perform the following process to determine whether a cartridge 100 accommodating approved toner was temporarily removed and then remounted. After S45 of the printing process shown in any of FIG. 9, 14, 18, or 23, the CPU 11 performs a process to store the remaining amount of each toner in a prescribed area of the flash memory 14 and subsequently performs a process to store the remaining amount of each toner in a prescribed area of the flash memory 114 provided in the wireless IC tag 110 as toner data. Further, in the mounting process shown in FIG. 6, the CPU 11 performs a process to extract data indicating the remaining amounts of toner from the toner data in place of the process described in S6 and to perform a process to determine whether the remaining amounts of toner extracted from the toner data match the remaining amounts of toner stored in the prescribed area of the flash memory 14 in place of the process in S7. If the corresponding amounts match, the CPU 11 may judge that a cartridge 100 accommodating approved toner has been temporarily removed and then remounted.

The following process may be performed to detect the remaining amount of toner in each color. The toner in each color is provided in an individual case accommodated in the cartridge 100. Each case has first windows disposed on one side of the case to allow the passage of light entering the case, and second windows disposed on the opposing side of the case to allow the passage of light exiting the case. A plurality of pairs of the first and second windows is arranged along the sides of the case in a direction for detecting the level of toner accommodated in the case as the level declines. With this configuration, the CPU 11 can detect the remaining amount of toner in each case based on the number of light beams that enter the first windows and exit the second windows.

In the first, second, third, and fourth embodiments described above, the image-forming unit 17 forms the test patches on the intermediate transfer member 30, but the image-forming unit 17 may form test patches on paper instead. Since the density sensor 19 measures the density of each test patch formed on paper with this method, the calibration process can be performed more accurately.

While the MFPs 10, 210, 310, and 410 in the first, second, third, and fourth embodiments employ a laser printer as the printing function, the printing function may be implemented by an inkjet printer instead.

Further, while an intermediate transfer type laser printer fulfills the printing function of the MFP 10 in the first, second, third, and fourth embodiments, a direct transfer type laser printer may instead be used to form each test patch on a conveying belt used to convey sheets of paper.

In the test patch measurement process of the first embodiment shown in FIG. 7, upon determining that a flag in the non-approved product flag area 13a is set to ON (S24: NO), the CPU 11 judges that the toner corresponding to the flag set to ON in the non-approved product flag area 13a is a non-approved product, acquires second calibration parameters from the second calibration parameter area 12b, and uses these parameters to convert the density sensory values to measured density values, but the present invention is not limited to this configuration. For example, if the CPU 11 determines in the test patch measurement process that toner accommodated in the cartridge 100 is a non-approved product, the CPU 11 may use the first calibration parameters acquired from the previously mounted cartridge 100 instead of the second calibration parameters to convert the density sensory values to measured density values, or may use the first calibration parameters acquired from the currently mounted cartridge 100 to convert density sensory values to measured density values. This is possible because the CPU 11 need only convert density sensory values to measured density values, since the second calibration parameters used when the toner is determined to be non-approved serve merely to calculate provisional measured density values in order to generate a high-density calibration table. In such cases, the CPU 11 may store the first calibration parameters acquired from the previously mounted cartridge 100 in a prescribed area of the flash memory 14. The above variation may also be applied to S74 of the test patch measurement process shown in FIG. 22.

Further, any of the MFPs 10, 210, and 310 described in the first through third embodiments may be suitably combined with the MFP 410 according to the fourth embodiment. In such cases, the CPU 11 can generate high-density calibration tables using target values for high-density calibration and high-density calibration parameters and can use the high-density color profiles in the printing process. Accordingly, the CPU 11 can form images on paper at a higher density for colors of toner accommodated in the cartridge 100 that are determined to be non-approved products than for colors of toner determined to be approved products.

What is claimed is:

1. A data processing device for a printing device, the printing device including a printing unit for printing an image based on image data using color material contained in a cartridge that is detachably mounted in the printing device and has a storage unit storing processing data, the data processing device comprising:
an original image data acquiring unit that is configured to acquire original image data;
a processing data acquiring unit that is configured to acquire the processing data from the storage unit;
a first processing unit that is configured to generate first image data using the original image data based on the acquired processing data if the processing data acquiring unit acquires processing data, the first image data being used for producing a first image by the printing unit;
a second processing unit that is configured to generate second image data using the original image data if the processing data acquiring unit does not acquire the processing data, the second image data being used for producing a second image by the printing unit, the second image having a density higher than a density of the first image; and
a supplying unit that is configured to supply one of the first image data and the second image data to the printing unit.

2. The data processing device according to claim 1, further comprising a processing data determining unit that is configured to determine whether or not the acquired processing data is suitable for characteristic of color material contained in the cartridge,
wherein the first processing unit is configured to generate the first image data if the processing data acquiring unit acquires processing data and the processing data determining unit determines that the acquired processing data is suitable; and
wherein the second processing unit is further configured to generate the second image data if the processing data acquiring unit acquires processing data and the processing data determining unit determines that the acquired processing data is not suitable.

3. The data processing device according to claim 2, further comprising:
a first identification data acquiring unit that is configured to acquire first identification data from the printing device, the first identification data identifying the printing device; and
a second identification data acquiring unit that is configured to acquire second identification data from the storage unit,
wherein the processing data determining unit is configured to determine that the acquired processing data is suitable if the first identification data is same as the second identification data, and
wherein the processing data determining unit is configured to determine that the acquired processing data is not suitable if the first identification data is different from the second identification data.

4. The data processing device according to claim 3, further comprising an identification data registering unit that is configured to register the first identification data in the storage unit as the second identification data if the storage unit does not stores the second identification data.

5. The data processing device according to claim 1, wherein the processing data includes first tone calibration data,
wherein the data processing device further comprises:
a first calibration table generating unit that is configured to generate a first calibration table based on the first tone calibration data included in the processing data;
a second tone calibration data storing unit that is configured to store second calibration data; and
a second calibration table generating unit that is configured to generate a second calibration table based on the second tone calibration data,
wherein the first processing unit is configured to generate the first image data by changing tone of pixels constituting the original image data in accordance with the first calibration table, and
wherein the second processing unit is configured to generate the second image data by changing tone of pixels constituting the original image data in accordance with the second calibration table, the second calibration table being set so that the second image has a density higher than a density of the first image, the second image being produced by the second image data that is generated in accordance with the second calibration table, the first image being produced by the first image data that is generated in accordance with the first calibration table.

6. The data processing device according to claim 5, wherein the first calibration table generating unit includes:
a first correlation acquiring unit that is configured to acquire first correlations between first tone values and first target values, each first target value being indicative of a target density for one first tone value;
a second correlation determining unit that is configured to determine second correlations between second tone values and first measured values, each first measured value corresponding to one second tone value and being indicative of a density that is determined based on the first tone calibration data;
a first determining unit that is configured to determine, for each first tone value, a first calibrated tone value based on the first correlations and the second correlations, the first calibrated tone value being one of the second tone values whose first measured value is equal to the first target value corresponding to the each first tone value; and
a first calibration table generating unit that is configured to generate the first calibration table, the first calibration table being indicative of correlations between the first tone values and the first calibrated tone values, and
wherein the second calibration table generating unit includes:
a third correlation acquiring unit that is configured to acquire third correlations between the first tone values and second target values, each second target value being indicative of a target density for one first tone value, the second target value for one first tone value being indicative of a target density higher than the first target value for the one first tone value;
a fourth correlation determining unit that is configured to determine fourth correlations between third tone values and second measured values, each second measured value corresponding to one third tone value and being indicative of a density that is determined based on the second tone calibration data;
a second determining unit that is configured to determine, for each first tone value, a second calibrated tone value based on the third correlations and the fourth correlations, the second calibrated tone value being one of the third tone values whose second measured value is equal to the second target value corresponding to the each first tone value; and
a second calibration table generating unit that is configured to generate the second calibration table, the second calibration table being indicative of correlations between the first tone values and the second calibrated tone values.

7. The data processing device according to claim 1, wherein the processing data includes tone calibration data;
wherein the data processing device further comprises:
a first calibration table generating unit that is configured to generate a first calibration table based on the tone calibration data; and
a second calibration table storing unit that is configured to store a second calibration table;
wherein the first processing unit is configured to generate the first image data by changing tone of pixels constituting the original image data in accordance with the first calibration table;
wherein the second processing unit is configured to generate the second image data by changing tone of pixels constituting the original image data in accordance with the second calibration table, the second calibration table being set so that the second image has a density higher than a density of the first image, the second image being produced by the second image data that is generated in accordance with the second calibration table, the first image being produced by the first image data that is generated in accordance with the first calibration table.

8. The data processing device according to claim 1, wherein the processing data includes a first color conversion information,
wherein the data processing device further comprises:
a first converting unit that is configured to convert the original image data to first converted image data based on a first color conversion table that is prepared using the first color conversion information, the original image data representing a color defined in a first color space, the first converted image data representing a color defined in a second color space, the second color space being different from the first color space;
a second color conversion table storing unit that is configured to store a second color conversion table; and
a second converting unit that is configured to convert the original image data to second converted image data based on the second color conversion table, the second converted image data representing a color defined in the second color space,
wherein the first processing unit is configured to generate the first image data based on the first conversion table if the processing data acquiring unit acquires the first color conversion table, and
wherein the second processing unit is configured to generate second image data based on the second color conversion table if the processing data acquiring unit does not acquire the first color conversion table, the second color conversion table being set so that the second image has a density higher than a density of the first image, the second image being produced by the second image data that is generated based on the second color conversion, the first image being produced by the first image data that is generated based on the first color conversion.

9. A data processing device for a printing device, the printing device including a printing unit for printing an image based on image data using color material contained in a cartridge that is detachably mounted in the printing device and has a storage unit storing processing data, the data processing device comprising:
an original image data acquiring unit that is configured to acquire original image data;
a processing data acquiring unit that is configured to acquire the processing data from the storage unit;
a processing data determining unit that is configured to determine whether or not the acquired processing data is suitable for characteristic of color material contained in the cartridge;
a first processing unit that is configured to generate first image data using the original image data based on the acquired processing data if the processing data determining unit determines that the acquired processing data is suitable, the first image data being used for producing a first image by the printing unit;
a second processing unit that is configured to generate second image data using the original image data if the processing data determining unit determines that the acquired processing data is not suitable, the second image data being used for producing a second image by the printing unit, the second image having a density higher than a density of the first image; and
a supplying unit that is configured to supply one of the first image data and the second image data to the printing unit.

10. A data processing method comprising:
acquiring original image data;
attempting to acquire processing data from a storage unit of a cartridge, the cartridge being detachably mounted in a printing device and containing color material therein, the printing device including a printing unit for printing an image based on image data using the color material;
generating first image data using the original image data based on the acquired processing data if the processing data is acquired, the first image data being used for producing a first image by the printing unit;
generating second image data using the original image data if the processing data is not acquired, the second image data being used for producing a second image by the printing unit, the second image having a density higher than a density of the first image; and
supplying one of the first image data and the second image data to the printing unit.

11. A data processing method comprising:
acquiring original image data;
acquiring processing data from a storage unit of a cartridge, the cartridge being detachably mounted in a printing device and containing color material, the printing device including a printing unit for printing an image based on image data using the color material therein;
determining whether or not the acquired processing data is suitable for characteristic of color material contained in the cartridge;
generating first image data using the original image data based on the acquired processing data if the acquired processing data is suitable, the first image data being used for producing a first image by the printing unit;
generating second image data using the original image data if the acquired processing data is not suitable, the second image data being used for producing a second image by the printing unit, the second image having a density higher than a density of the first image; and
supplying one of the first image data and the second image data to the printing unit.

12. A computer-readable recording medium that stores a data processing program, the data processing program comprising instructions for:
acquiring original image data;
attempting to acquire processing data from a storage unit of a cartridge, the cartridge being detachably mounted in a printing device and containing color material, the printing device including a printing unit for printing an image based on image data using the color material;
generating first image data using the original image data based on the acquired processing data if the processing data is acquired, the first image data being used for producing a first image by the printing unit;
generating second image data using the original image data if the processing data is not acquired, the second image data being used for producing a second image by the printing unit, the second image having a density higher than a density of the first image; and
supplying one of the first image data and the second image data to the printing unit.

13. A computer-readable recording medium that stores a data processing program, the data processing program comprising instructions for:
acquiring original image data;
acquiring processing data from a storage unit of a cartridge, the cartridge being detachably mounted in a printing device and containing color material, the printing device including a printing unit for printing an image based on image data using the color material;
determining whether or not the acquired processing data is suitable for characteristic of color material contained in the cartridge;
generating first image data using the original image data based on the acquired processing data if the acquired processing data is suitable, the first image data being used for producing a first image by the printing unit;
generating second image data using the original image data if the acquired processing data is not suitable, the second image data being used for producing a second image by the printing unit, the second image having a density higher than a density of the first image; and
supplying one of the first image data and the second image data to the printing unit.
